(19) United States
(12) Patent Application Publication
(10) Pub. No.: US 2023/0004951 A1
(43) Pub. Date: Jan. 5, 2023

(54) PROVIDING A BUY NOW PAY LATER PRODUCT TO A CREDIT ACCOUNT HOLDER

(71) Applicant: Comenity LLC, Columbus, OH (US)

(72) Inventors: Chris ANDERSON, Powell, OH (US); Jennifer DODOVSKI, Columbus, OH (US)

(73) Assignee: Comenity LLC, Columbus, OH (US)

(21) Appl. No.: 17/457,648

(22) Filed: Dec. 3, 2021

Related U.S. Application Data
(60) Provisional application No. 63/217,270, filed on Jun. 30, 2021.

(51) Int. Cl. G06Q 20/24; G06Q 20/32; G06Q 40/02

(52) U.S. Cl. CPC G06Q 20/24; G06Q 20/3223; G06Q 40/025; G06Q 30/0215

(57) ABSTRACT

A system and method for providing a buy now pay later (BNPL) product to a credit account holder is disclosed. The method receives a BNPL application from a customer, the BNPL application including customer identification information. The identification information for the customer is used to identify an existing credit account. A BNPL product with associated terms is generated based on the existing credit account. The BNPL product with associated terms is provided to the customer's mobile device. After accepting the BNPL product with associated terms the BNPL product is received at the customer's mobile device. The BNPL product is used to complete a transaction during a checkout process.

### CROSS-REFERENCE TO RELATED APPLICATIONS (PROVISIONAL)

This application claims priority to and benefit of co-pending U.S. Provisional Patent Application No. 63/217,270, filed on Jun. 30, 2021, entitled “PROVIDING A BUY NOW PAY LATER PRODUCT TO A CREDIT ACCOUNT HOLDER” by Christ Anderson et al, and assigned to the assignee of the present application, the disclosure of which is hereby incorporated herein by reference in its entirety.

### BACKGROUND

Company specific, brand specific or even store specific credit offering opportunities provide significant value to both a customer and a provider. By providing a new and different payment opportunity, the provider is able to tailor rewards offers, provide loyalty discounts and maintain customer brand loyalty. Similarly, the customer receives the perks from the reward offers and the loyalty discounts. In addition, a customer receiving the new and different payment opportunity is likely to tell others via word of mouth, social networks, internet rating sites, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a top plan view of a retail establishment having a point of sale (POS), in accordance with an embodiment.

FIG. 2 is a block diagram of a mobile device, in accordance with an embodiment.

FIG. 3 is a block diagram of a user specific information engine accessing one or more different search locations, in accordance with an embodiment.

FIG. 4 is a block diagram of a system for adding a BNPL product pass 170 with purchase capability to a mobile wallet, in accordance with an embodiment.

FIG. 5A is a flow chart of a method for mobile credit acquisition, in accordance with an embodiment.

FIG. 5B is a flow chart of a method for utilizing the device identifier and the user identifier to obtain user specific information, in accordance with an embodiment.

FIG. 5C is a flow diagram of a method for utilizing the new account in the mobile wallet of a mobile device, to make a transaction, in accordance with an embodiment.

FIG. 6A is a block diagram of a BNPL offer in accordance with an embodiment.

FIG. 6B is a screen capture of a BNPL application including the payment option terms and conditions as viewed on a customer's mobile device, in accordance with an embodiment.

FIG. 6C is a screen capture of the BNPL application requesting a verification code as viewed on a customer's mobile device, in accordance with an embodiment.

FIG. 6D is a screen capture of the customer's account and the BNPL product ready for use as viewed on a customer's mobile device, in accordance with an embodiment.

FIG. 6E is a front view of an exemplary retail transaction computing system located at store 100, in accordance with an embodiment.

FIG. 6F is a screen capture of a confirmation that the BNPL product has been used to make a transaction as viewed on a customer's mobile device, in accordance with an embodiment.

FIG. 7 is a flowchart of a method for providing a customer with a BNPL product having a number of payment scenarios, in accordance with an embodiment.

FIG. 8A is a block diagram of an example fraud detection system, in accordance with an embodiment.

FIG. 8B is a flowchart of a method for using position location information to pre-populate information on a BNPL application, in accordance with an embodiment.

FIG. 8C is a flowchart of a method for using position location information to verify information on a BNPL application, in accordance with an embodiment.

FIG. 9 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile device, and electronic personal display, among others. The electronic mobile device/system manipulates and transforms data represented as physical (electronic) quantities within the circuits, electronic registers, memories, logic, and/or components and the like of the electronic mobile device/system into other data similarly represented as physical quantities within the electronic mobile device/system or other electronic mobile devices/systems.

It should be appreciated that the obtaining, accessing, or utilizing of information conforms to applicable privacy laws (e.g., federal privacy laws, state privacy laws, etc.).

### Overview

The following discussion provides a novel approach for seamlessly providing an existing credit account customer with a buy now pay later (BNPL) payment opportunity that can be applied away from the point of sale (POS) and then used by the customer after approval and at the time of checkout instead of paying for the transaction using the customer's existing credit card account.

Embodiments described herein are used to obtain enough data about a customer, including data such as a customer's known behavior, any retailer-based customer information, any credit account provider customer history, and the like, to provide a customer with personalized BNPL product.

Embodiments described herein utilize retail computing devices, customer mobile devices, store computing systems and interactions therebetween (including messages, instructions, options, opportunities, customer feedback, and the like) in conjunction with the customer data, customer inputs, payment provider goals, and real-time adjustable terms, payment scenarios, and the like to develop a plurality of real-time payment scenarios that can be offered to a customer at or before the time of transaction. Moreover, the embodiments disclosed herein are available in actual stores and in virtual (e.g., Internet shopping) environments.

In one embodiment, the features disclosed herein will cause a lift-in conversion and increase in the customer's first purchase amount. In one embodiment, the features disclosed herein will increase acquisition across a payment provider's product portfolio. In one embodiment, the features disclosed herein will develop a customer's credit history. In one embodiment, the features disclosed herein will establish and build upon a customer-payment provider relationship.

In the following discussion, the term “retailer” is used to define a company or conglomeration that includes one or more brands. The term “brand” refers to a specific section of the retailer that includes a number of stores. The term “store” refers to a single sales location, a store could be a physical store (e.g., brick and mortar) or it could be a virtual store (e.g., a location that is accessed via the web).

The term “customer” is used herein to describe an actual or potential consumer of the retailer's goods and/or services.

The term “co-branded credit account” is used herein to describe a general purpose open-end revolving line of credit which is established by a credit provider for an accountholder pursuant to the terms of a credit agreement and in accordance with credit account association rules and regulations, and marketed with the retailer's mark and the trade names and/or logos of a credit account association. In one embodiment, a co-brand credit card has a major/well-known credit card provider Logo in conjunction with a brand specific emblem. The co-brand credit card can be used anywhere (or almost anywhere) a credit card can be used. There can be rewards, offers, financing, etc. as customer incentive. It is an open-ended, revolving credit product. There is often a credit limit, you can purchase as long as there is credit available, it is paid down by the customer making payments (monthly, minimum, in-full, overtime, etc.), and it remains an open account indefinitely, e.g., until canceled by customer or by credit account provider.

In one embodiment, the co-branded credit account can have an associated physical card, e.g., a credit card that is carried by a customer and includes the credit account information required for a purchase. In one embodiment, the co-branded credit account can have an associated virtual card that can be stored in a mobile wallet or otherwise digitally stored by the customer and includes the credit account information required for a purchase. In one embodiment, the co-branded credit account can have both a physical card and a virtual card.

The term “private label credit card” (PLCC) is used herein to describe a credit account that is intended for use at a specific brand of stores. The PLCC is a type of revolving credit plan managed by a bank or commercial finance company. The PLCC is often issued without an expiration date. In one embodiment, a branded credit card can be used at any store under the brand/retailer. In one embodiment, there may be lower credit limits than a co-branded credit card. In one embodiment, branded credit cards can include rewards, offers, financing, etc. as customer incentive. It is an open-ended, revolving credit product. There is often a credit limit, you can purchase as long as there is credit available, it is paid down by the customer making payments (monthly, minimum, in-full, overtime, etc.), and it remains an open account indefinitely, e.g., until canceled by customer or by credit account provider.

In one embodiment, the PLCC account can have an associated physical card, e.g., a credit card that is carried by a customer and includes the credit account information required for a purchase. In one embodiment, the PLCC account can have an associated virtual card that can be stored in a mobile wallet or otherwise digitally stored by the customer and includes the credit account information required for a purchase. In one embodiment, the PLCC account can have both a physical card and a virtual card.

In one embodiment, a PLCC can be part of a “universal PLCC” (UPLCC) which is a private label account that issues with an association logo on the back of the associated credit card, the UPLCC usually has limited use. In some cases, the UPLCC can be a part of a conglomeration of different brands that utilize the same card association. For purposes of clarity, in the following discussion the term PLCC is used to describe both the PLCC and the UPLCC.

The term “cardholder” is used herein to describe a customer that has at least one credit account. As discussed herein, the cardholder could be a customer with a physical card, a virtual card, or both a physical and a virtual card.

The term “buy now pay later (BNPL)” is used herein to refer to a payment product that is not a new credit product being opened and/or established. Instead, a customer's existing account (such as a debit card, a bank card, a bank account, a co-brand credit account, a PLCC account, a UPLCC account, an installment loan, or the like), is used to back the BNPL product which is generated and used to perform the transaction.

Prior to the time of the transaction, the customer provides the account to be used to obtain payments therefrom and the payment plan is established and agreed upon by the customer. In one embodiment, the BNPL will make an initial payment charge to the customer's credit account (or other customer accounts as discussed above) at the time of the transaction, and then the rest of the payments for the purchase will be automatically charged as installment payments from the credit account provided and based on the customer accepted terms in the BNPL agreement.

In the following discussion, a mobile device (or mobile phone) refers to a computing device that has ingrained telephony capability via a mobile carrier.

In contrast, a non-phone mobile device refers to any computing device such as a laptop, desktop, notebook, or the like that does not have ingrained telephony capability via the mobile carrier. Thus, a mobile device that utilizes only the Internet, Wi-Fi, or the like to make phone calls would be an example of a non-phone mobile device.

In general, a BNPL application obtains identification information about a customer and uses the identification information to make a BNPL determination. For example, if a customer wants to obtain BNPL financing, the customer would have to provide identifying information for the customer, the customer's mobile device, or a combination thereof. The identifying information is used to identify a customer's existing credit account and, in one embodiment, perform a credit check of the customer's credit history and qualifications based on the BNPL issuer's criteria.

It should be appreciated that the obtaining or accessing of customer information conforms to applicable privacy laws (e.g., federal privacy laws, state privacy laws, etc.) and applicable fair credit reporting act laws. In one embodiment, prior to accessing customer information, the customer affirmatively “opts-in” to the services described herein. Moreover, depending on present or future credit account requirements, rules and regulations, the BNPL application aspects described herein may be more or less formal.

In one embodiment, if the BNPL application is web-based, it may not be able to access the GPS data on the mobile device. However, in one embodiment, the web-based app is able to use the location information provided by the communication provider (carrier) to obtain location data that is similar to the mobile device GPS data. One way to obtain the information would be to use an API to push the carrier information to the mobile web application.

In one embodiment, the BNPL application is a non-integrated application, e.g., custom code is hosted and managed by credit account provider. In one embodiment, the BNPL application is an integrated application, e.g., it provides a brand the bones of the front end such that the brand can host and modify the front end based on their own individualized criteria, while the back end remains hosted and managed by the BNPL provider. In one embodiment, the application is a hybrid, e.g., the BNPL provider will host and manage the entire product, but they will receive front end input/design/criterion from the brand that will be used by the BNPL provider to customize the front end for the brand.

### Operation

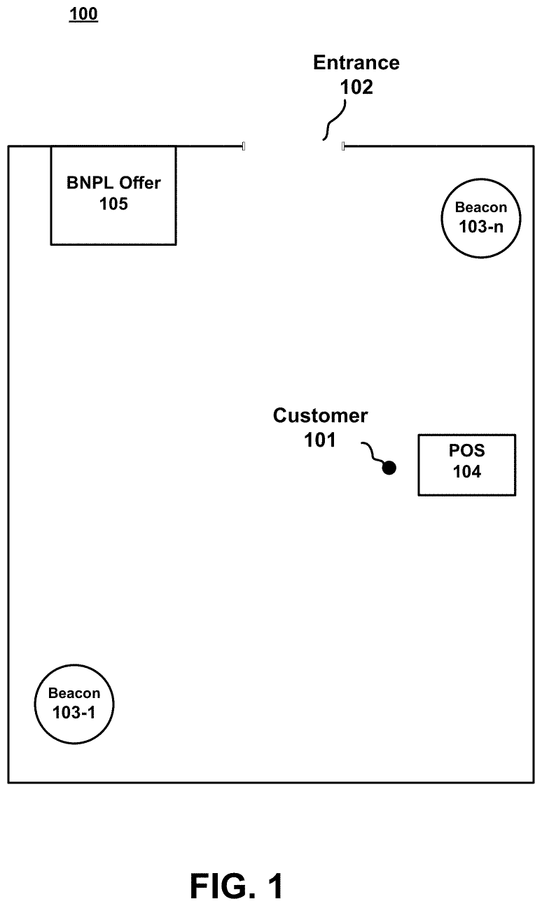

Referring now to FIG. 1, a top plan view of a store 100 having a POS 104 is shown in accordance with an embodiment. In general, store 100 is any physical brick and mortar store that provides goods for sale. In one embodiment, store 100 includes an entrance 102. In addition, in different embodiments and configurations, store 100 can include one or more of, a poster or other presentation of BNPL offer 105, a customer 101, and POS 104.

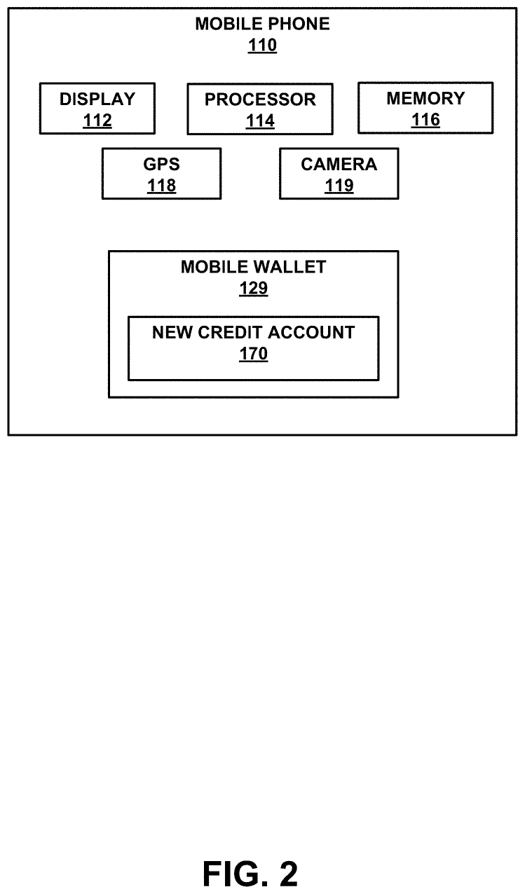

Referring now to FIG. 2, a block diagram of a mobile device 110 is shown. In one embodiment, mobile device 110 includes a display 112, a processor 114, a memory 116, a GPS 118 (or other location determining application), a camera 119, and the like.

Mobile device 110 also includes a mobile wallet 129 which is an electronic application that operates on mobile device 110. Mobile wallet 129 includes BNPL product pass 170. In general, BNPL product pass 170 allows a customer to utilize a single mobile payment method that is linked to one or more credit account information, reward account information, offers, coupons, and the like, and is carried in a secure digital form on a mobile device 110. Instead of using a physical plastic card to make purchases, a mobile wallet allows a customer to pay via mobile device 110 in stores, in apps, or on the web.

In general, mobile device 110 is an example of a customer's mobile device. Mobile device 110 could be a mobile phone, a smart phone, a tablet, a smart watch, a piece of smart jewelry, smart glasses, or other customer portable devices having wireless telephony connectivity via a mobile service provider. In one embodiment, mobile device 110 is also capable of broadcasting and receiving via at least one network, such as, but not limited to, WiFi, Bluetooth, near field communication (NFC), and the like.

GPS 118 can generate and provide location information with respect to the customer's mobile device. The output from GPS 118 could be utilized by an operating system of mobile device 110, an application (app) loaded on mobile device 110, a web-based app accessed over a network by mobile device 110, or the like. In one embodiment, the output from GPS 118 could be provided to another computing system for identification purposes, fraud determination and/or evaluation, etc. In one embodiment, instead of providing GPS information, the location of mobile device 110 may be determined within a given radius, such as the broadcast range of an identified beacon, a WiFi hotspot, overlapped area covered by a plurality of mobile telephone signal providers, or the like.

Although a number of components are shown as part of mobile device 110, it should be appreciated that other, different, more, or fewer components may be found on mobile device 110.

Referring again to FIG. 1, in one embodiment, BNPL offer 105 may be located by the entrance 102 to store 100, in a section of the store such as a furniture, clothing, shoe section or the like. BNPL offer 105 may be presented on a physical item or electronically such as via a poster, display screen, text link, URL, NFC, beacon, WiFi broadcast, RFID broadcast, or the like. In one embodiment, the BNPL offer 105 includes a visual and/or an aural capturable code. In one embodiment, the capturable code will be one or more of a 1-Dimensional (1D) code, 2-Dimensional (2D) visual image codes such as, but not limited to, a barcode, universal product code (UPC), matrix barcode, quick response (QR) code, Micro QR code, IQR code, Secure QR (SQR) code, Frame QR code, high capacity colored 2D (HCC2D) code, SPARQCode, just another barcode (JAB code), portable data file (PDF) 417, SnapTag, Aztec code, 3-Dimensional (3D) code, a sound code such as Touchatag, TikiTag, etc., a picture code, a video code, or the like.

In one embodiment, the capturable code can be in-store, on-line, or the like. In-store examples of the BNPL offer 105 could be a poster or other media on a wall in the store 100, a tri-fold or other media by the POS 104, displayed on a screen in the store, displayed on an associate's tablet or other mobile device in the store, printed on the floor, etched in the glass, part of a sticker, etc. On-line examples include the BNPL offer 105 displayed on a webpage, in an app, and the like.

In one embodiment, the interaction between the customer's mobile device and the BNPL offer 105 feature is initiated by the customer's mobile device interacting with the BNPL offer 105. For example, in one embodiment, BNPL offer 105 is scanned by the customer 101 with the customer's mobile device 110.

In one embodiment, BNPL offer 105 is provided via a beacon such as one or more of beacons 103-1 through 103-n. In general, the one or more of beacons 103-1 through 103-n are devices that are configured to be communicatively coupled with customer's mobile device 110, such as via NFC, Bluetooth, WiFi, or the like. In one embodiment, one or more of beacons 103-1 through 103-n is an iBeacon™, which is an indoor positioning system from Apple Inc. For example, the iBeacon is a low-powered, low-cost transmitter that can notify nearby iOS and/or Android devices of their presence. Although an iBeacon is provided as a specific example, the beacons are not limited to only that brand. Different beacons from other companies would also be acceptable.

In one embodiment, the result of the customer's mobile device 110 interacting with the BNPL offer 105 is the generation of an electronic message (e.g., a text message, email, etc.) that is formatted and addressed (e.g., a text number or other short code) to deliver the electronic message to the appropriate agency. By having the BNPL offer 105 interaction cause the customer's mobile device 110 to automatically generate and format the electronic message, the customer is saved the time required to open and address the electronic message. Moreover, the insertion of clerical errors will be reduced/removed since the customer is not keying in the formatted information (e.g., appropriate agency email, short code, text number, or the like).

In one embodiment, since the electronic message is formatted from instructions provided during the customer's mobile device 110 interaction with the BNPL offer 105, the initial generated electronic message will include whatever information was predefined to be obtained by the BNPL offer 105 as deployed by the appropriate agency. Such information could include a request for customer ID information, a request for device ID information, a generation of metadata associated with the electronic message that includes device ID information, location information, customer ID information, etc. In one embodiment, the automatic generation of the electronic message from the interaction with the BNPL offer 105 could include automatic insertion of one or more pieces of customer or device information, a request for authorization to send an email with the automatically inserted information, a request for manual input of one or more of the pieces of information, a combination of automatic and manually input information, or the like.

In one embodiment, BNPL offer 105 is provided by an application on the customer's mobile device 110 after the customer's mobile device 110 is determined to be in store 100, within range of beacon 103-1 and/or 103-n. In yet another embodiment, the BNPL offer 105 is provided on the customer's mobile device 110 when a location capability of the customer's mobile device 110 determines that the customer 101 is located near store 100. In general, near store 100 refers to a location such as, within the bounds of the store, within a few yards of the store, within the mall in which store 100 is located, within a beacon or WiFi broadcast range of store 100, or within a block of store 100.

For purposes of the present discussion, the mobile device location service, can be, but is not limited to, GPS, WiFi, cellular service, beacon derived location determination and the like. Moreover, the location determined by the mobile device location service may be useful even at differing levels of accuracy. For example, a GPS enabled mobile device 110 can provide location information that is accurate to within a few meters while a cellular service, beacon or WiFi location capabilities of mobile device 110 can provide a location radius or location area. For example, the mobile device 110 being located within range of a beacon, within the overlapping area of a number of cellular service towers, etc.

In one embodiment, the location of the mobile device can be determined via geo-fence, beacon range, a ping, NFC, WiFi, or the like. Moreover, the location may be an actual location or a relative location.

For example, actual location information may be obtained by the customer's mobile device location services, such as but not limited to, GPS, WiFi, cellular service, beacon derived location determination, and the like. Moreover, the location determination can be useful even at differing levels of accuracy. For example, a GPS enabled mobile device would provide location information that is accurate to within a few meters and would be lat long coordinates (or similar).

In contrast, relative location information is location information determined via a broadcasting or receiving station (e.g., cellular service, beacon, WiFi access point, hotspot, or the like). The relative location would be the location of the station and a broadcast radius (or area) of coverage for the station. Moreover, if the device is picked up by two or more different stations, then the location could be further refined as being within the overlapping broadcast radii of the number of different stations. For example, although the actual location of the mobile device may not be known, if the mobile device is interacting with a beacon 103-n, then the relative location of the mobile device would have to be in range of beacon 103-n broadcast radius. Similarly, a geo-fence could be used to determine that the location of the mobile device is within the defined geo-fenced area, although the actual location of the mobile device within the geofenced area may not be known.

In one embodiment, mobile device 110 will use a positioning determining system such as global positioning system (GPS) or the like to determine location information. In another embodiment, the mobile device may be able to determine a location within a given radius, such as the broadcast range of a beacon, WiFi hotspot, overlapped area covered by a plurality of mobile telephone signal providers, or some combination thereof.

BNPL application is accessed at a web site, from an in-store application, by scanning a visual code such as a barcode, a QR code on a physical item such as a poster, or the like. In another embodiment, the BNPL offer 105 is received by a beacon broadcast, WiFi broadcast, email, or the like. In one embodiment, BNPL application obtains authorization from mobile device 110 to access location information on the mobile device 110.

Location information refers to the location of the mobile device 110 at different times of the day as generated by a positioning system on the mobile device 110, by location information on the customer's home computer system or the like. Because of the different positioning systems available on a mobile device and/or a non-phone mobile device, the location information can include differing levels of accuracy. For example, a GPS enabled mobile device 110 can provide location information that is accurate to within a few meters or less. In contrast, location information derived from cellular service, beacon, WiFi location capabilities, and the like can provide a location radius or location area that may be within 10-50 meters or even larger.

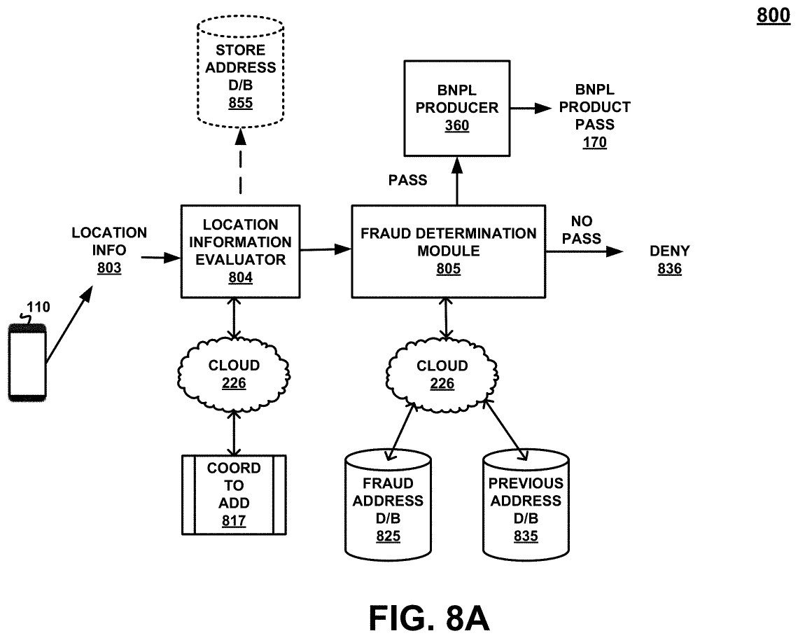

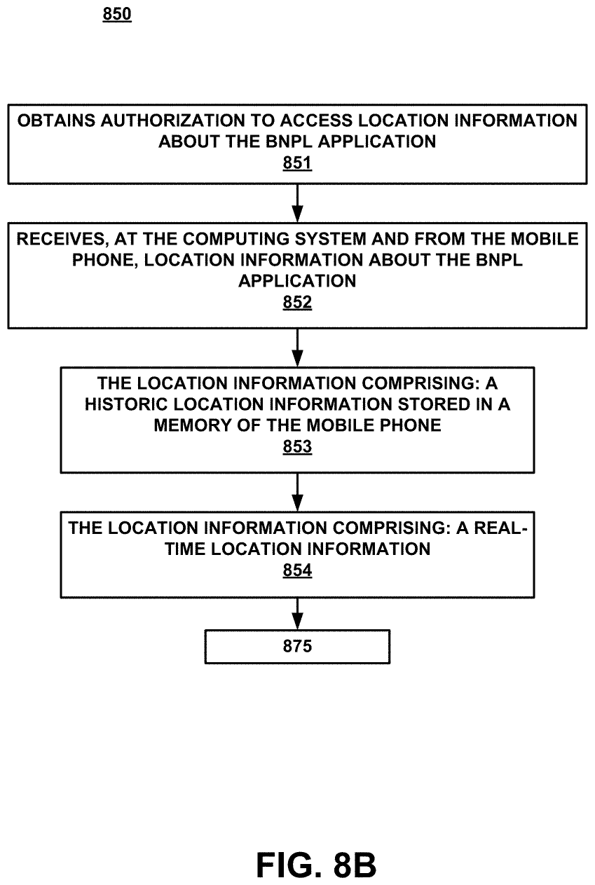

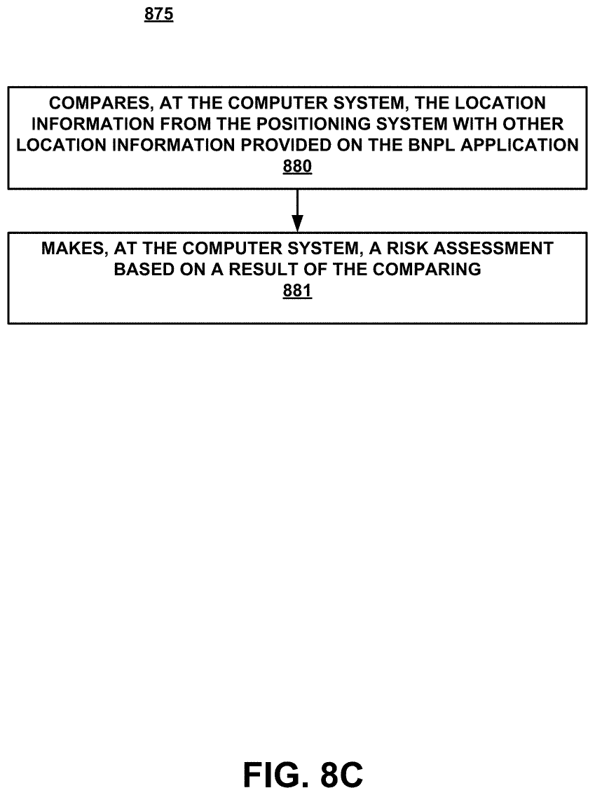

In one embodiment, a location information evaluator uses location information to determine an actual address. For example, in one embodiment, the location information provided by mobile device 110 are provided as coordinates data. In order to determine an address, location information evaluator cross-references the coordinate data with one or more different coordinate-to-address determination sources such as: mapping software, surveyor data that includes business and/or residential information, County assessor's information, or other coordinate-to-address determiners. Further operation of location information evaluator is shown and described in FIGS. 8A-8B.

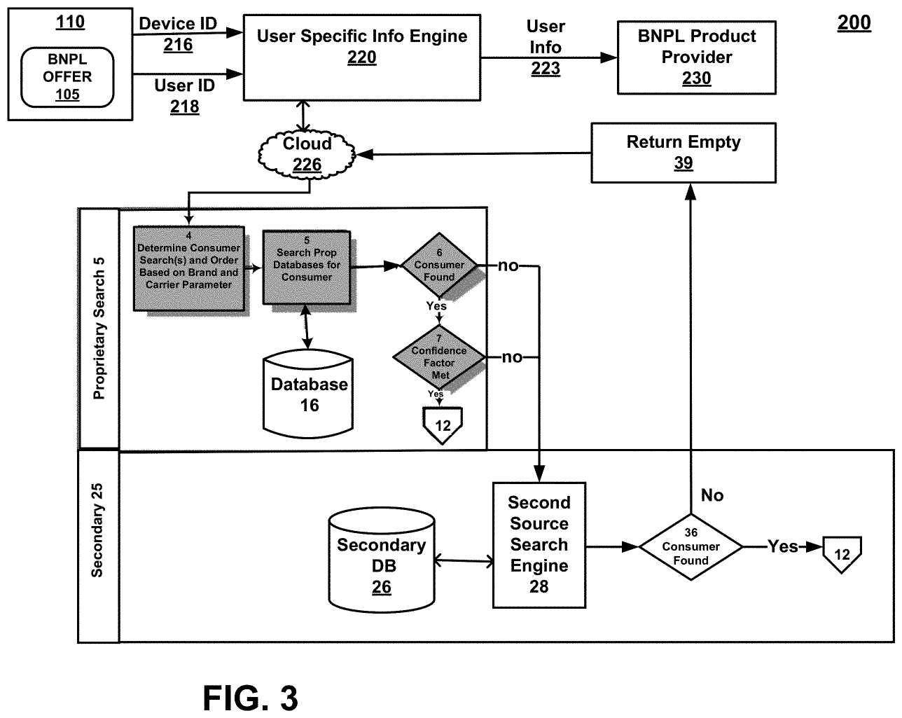

Referring now to FIG. 3, a block diagram of a customer identification system 200 is shown in accordance with an embodiment. In one embodiment, customer identification system 200 includes a BNPL offer 105, mobile device 110, a user specific information engine 220, and a BNPL product provider 230. Although a number of applications and components are shown in customer identification system 200, it should be appreciated that the components and applications may be located separately from one another. For example, one or more of the components and applications may be found on one or more locations, such as, but not limited to, a computer in the store 100, a server at a remote location, on the cloud 226 or the like.

In general, BNPL offer 105 is an offer for a BNPL product intended to be used for a single purchase. In one embodiment, BNPL offer 105 may include an incentive such as a discount percentage, a free gift, a coupon, a surprise gift, a surprise reward, or the like. As stated herein, BNPL offer 105 may be located on a physical item or received by the customer's mobile device, e.g., via a beacon broadcast, WiFi broadcast, email, text, SMS, social media alert, app alert, or the like. In yet another embodiment, BNPL offer 105 may be provided by an app on the customer's mobile device once the mobile device is within a certain vicinity of the store.

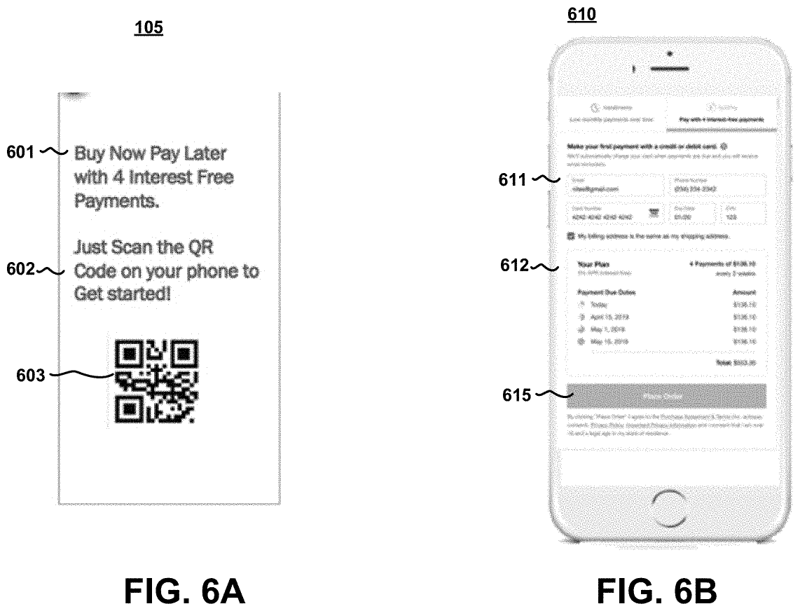

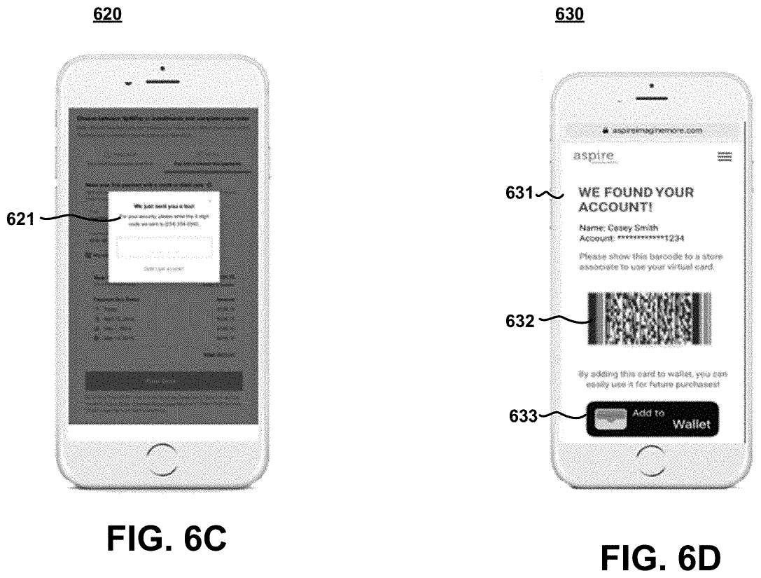

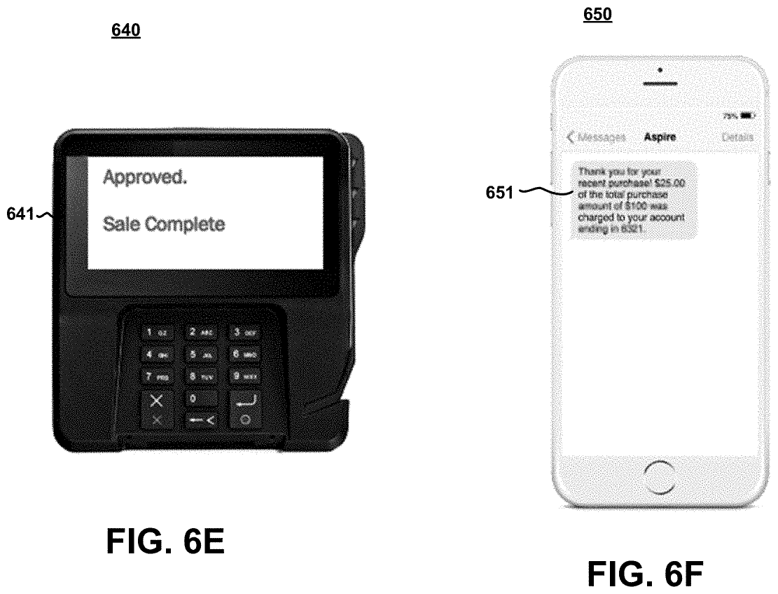

A number of different options may be available to respond to the BNPL offer 105. For example, the response may be in the form of a message interaction, as shown and described in further detail in FIGS. 6A through 6F. In one embodiment, the response to the BNPL offer 105 requires the customer to provide a device ID 216 and a user ID 218.

In general, device ID 216 can be different depending upon the device. For example, a mobile device ID: includes identification characteristics such as, a mobile device telephone number or mobile device ID such as the mobile device's serial number, international mobile equipment identity (IMEI), integrated circuit card identifier (ICCID) (e.g., the SIM card number), mobile equipment identifier (MEID), secure element chipset identify (SEID), a media access control (MAC) address, Internet protocol (IP) address, universal unique identifier (UUID), model number, product number, serial number, or the like.

In one embodiment, device ID 216 that is requested for the process is based upon an evaluation of which of the possible device IDs would provide the best capability for fraud prevention. For example, a customer's mobile number could be easily obtained (e.g., via social media, public records, white pages, Internet search, etc.) so it would be a lower device ID option on a fraud scale. In contrast, the customer's mobile device serial number, IMEI, ICCID, MEID, SEID, or the like is much less likely to be obtained fraudulently (via social media, public records, guessed, etc.) so it may be that one of the IMEI, ICCID, MEID, SEID, or the like would be the device ID with the highest fraud prevention value.

User ID 218 can be the customer's identification information such as, name, zip code, social security number or portion thereof, driver's license number or portion thereof, or the like that is used to identify a specific customer.

In one embodiment, the user ID 218 that is requested for the process is based upon an evaluation of which of the possible user IDs would provide the best capability for fraud prevention. For example, a customer's birthday could be easily obtained (e.g., via social media, public records, etc.) so it would be a lower user ID option on a fraud scale. Similarly, a customer's address could be easily obtained (e.g., via social media, public records, etc.) so it would also be a lower user ID option on a fraud scale. Further, a customer's email could be easily obtained (e.g., via social media, public records, etc.) or easily guessed, so it would also be a lower user ID option on a fraud scale. In contrast, a social security number (or last four, six, seven, five, middle three, five, first 6, 7; middle three+last two; or any other amount or combination of the nine social security numbers) is much less likely to be obtained fraudulently (e.g., via social media, public records, guessed, etc.) so it may be that a pre-selected portion of the SSN (or a changing selected portion of the SSN) would be the user ID with the highest fraud prevention value.

Thus, a customer's response to BNPL offer 105 will include enough information for the customer identification system 200 to identify the customer 101 for purposes of providing the customer with a BNPL application.

In one embodiment, user specific information engine 220 will receive a message from a customer's mobile device 110 in response to the BNPL offer 105. The message will include device ID 216 and user ID 218.

In one embodiment, user specific information engine 220 will use device ID 216 and user ID 218 to obtain user specific information 223 to prepopulate an electronic form such as a BNPL application. In general, user specific information 223 could be at least two of: a name and full or partial address, a driver's license number, a social security number, or the like.

In one embodiment, user specific information engine 220 may access the different search locations via the cloud 226. An example of cloud 226 is a network such as the Internet, local area network (LAN), wide area network (WAN), or the like.

One embodiment uses the device ID 216 and user ID 218 information to perform a proprietary search 5 of at least one proprietary database 16. In general, the proprietary database 16 may be one or more databases such as a credit accounts database, or the like, that store a company's private database such as an Alliance Data Legacy database or the like. Proprietary database 16 will include user specific information 223 for customers that have existing accounts with the company, have previously applied for an account, or the like.

In one embodiment, the proprietary search 5 will only search a database related to a specific company. For example, if the BNPL product provider 230 is a specific company, e.g., Nash's skate and bike emporium, then in a company specific database search, only the existing customer information related to Nash's skate and bike emporium will be searched. For example, a check is performed to see if the customer has an existing PLCC account, e.g., is already an existing customer in the database.

However, if the proprietary search 5 is for a group of companies, a shared information database, or the like, then all of the customer information in the databases may be searched for a match with the device ID 216 or the user ID 218. For example, if the database includes Nash's skate and bike, Mike's hardware, and Tarrin's dress stores, and all three companies are sharing information, then the search would encompass all three store's databases of information.

For example, the search would use an internal account holder proprietary database 16 to see if the customer has another account within the shared information database. If the customer does not have a Nash's skate and bike account, the underlying credit account management, e.g., Alliance Data database, is searched to see if the customer has an account at a different brand associated with Alliance Data. In one embodiment, the customer's existing account could be a co-brand credit account, a PLCC account, a UPLCC account, an installment loan, another BNPL product, or the like.

In one embodiment, customer information 6 that is found in the proprietary database 16 will be verified using a confidence factor 7. For example, if only one record is found and it is 5 days old, the confidence in the found records would likely be below the confidence factor threshold. In contrast, if 2 years of records are found, such as prior accounts, present accounts, memberships, rewards information, and the like, then the confidence in the user specific information 223 found in the records would be above the confidence factor threshold. If the user specific information 223 is above the confidence factor threshold, then the user specific information 223 is deemed valid. At that point, the user specific information 223 is returned via return information 12 to user specific information engine 220 and then passed on to BNPL product provider 230.

One embodiment incorporates one or more of several fraud mitigation business rules to attempt to prevent fraudulent activity; e.g., to validate the found records. These business rules include logic that looks at specific activity on a customer's account that point to potentially fraudulent activities. In addition, a fraud mitigation tool may be implemented. The fraud mitigation tool will use device and internet protocol (IP) information to predict if the BNPL application can be trusted or will eventually become fraudulent.

For example, in one embodiment, the fraud mitigation tool will ignore any credit accounts that meet situations such as, but not limited to, the following: It is associated within a brand(s) that have been determined to have a high propensity for fraud. It is currently in a derogatory status. The account was opened within a defined number of days, where the number of days is controlled by internal parameters and can be tightened, loosened or turned off. The phone number matched has been changed within a defined number of days, where the number of days is controlled by internal parameters and can be tightened, loosened or turned off. An authorized buyer has been added to the account within a defined number of days, where the number of days is controlled by internal parameters and can be tightened, loosened or turned off. The address has been changed within a defined number of days, where the number of days is controlled by internal parameters and can be tightened, loosened or turned off. The account has been inactive within a defined number of months, where the number of months is controlled by internal parameters and can be tightened, loosened or turned off. Multiple accounts are found for the mobile device number, zip code and last 4 digits of the SSN but all accounts are not the same person, and the like.

If no user specific information 223 is found during the proprietary search 5 or if the found user specific information 223 cannot be validated, then the device ID 216 and user ID 218 are passed on to a secondary search 25. At secondary search 25, a second source search engine 28 will search at least one secondary source database 26. One example of secondary source database 26 is a reverse phone number look up. However, other secondary source databases may be searched such as, but not limited to: social media sites, search engines, online public and/or private records, reverse name and phone number engines, and the like. In one embodiment, the user specific information 223 may be obtained by performing a secondary source database 26 search with the user ID 218 and the device ID 216.

In one embodiment, the secondary search 25 may be for example, a real-time call to a reverse phone look-up product to try and locate the customer. In general, reverse phone look-up products provide accurate and current customer telephone information. In many cases, the data is updated regularly from a broad range of sources, including regional bell operating companies, white pages and proprietary sources. One embodiment also integrates validation and authentication aspects that add further benefits to append address information for a customer. In general, validation and authentication aspects match customer name and zip code information that was returned from the reverse phone look-up, against data from a secondary source to return full address data.

If the customer is found 36, then the user specific information 223 is returned via return information 12 to user specific information engine 220. If no user specific information 223 is found from the secondary search 25, then no user specific information 223 will be pre-populated into the forms. That is, the user specific information engine 220 will receive a return empty 39. However, if a match is made, then the user specific information 223 can be used to prepopulate a portion of the application, e.g., name, address, city, state, zip, mobile device number, email, etc.

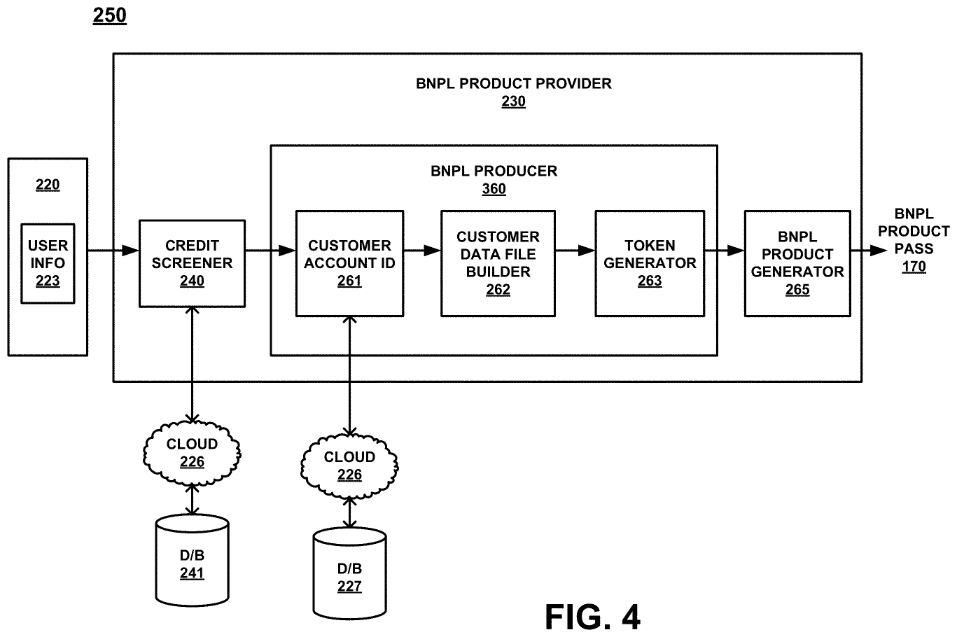

Referring now to FIG. 4, a block diagram of a system 250 for adding a new BNPL product pass 170 with purchase capability to mobile wallet 129 of a customer's mobile device 110 is shown in accordance with an embodiment. In one embodiment, system 250 shows the user specific information engine 220 providing the user specific information 223 to BNPL product provider 230 in accordance with one embodiment. In one embodiment, BNPL product provider 230 includes a credit screener 240, a BNPL producer 360, and a BNPL product generator 265. Although a number of applications and components are shown, it should be appreciated that there may be more or fewer components and applications of BNPL product provider 230. Moreover, different pieces may be combined, re-organized, located separately from one another, or the like.

In general, credit screener 240 accesses a credit reporting agency database 241, such as a credit reporting agency, via cloud 226 to determine credit information for the customer based on the user specific information 223. An example of cloud 226 is a network such as described herein. The credit reporting agency could be a company such as, but not limited to, Experian, Equifax, TransUnion, Innovis and the like.

Credit screener 240 will analyze the customer's credit information obtained from the credit reporting agency database 241 to determine if the customer passes the credit criteria. If the customer does not pass the credit screening process, no further action is taken.

In one embodiment, after the customer passes the credit screening then BNPL product provider 230 provides an application for a BNPL product to the customer's mobile device. In one embodiment, BNPL product provider 230 populates the application for the BNPL product with the user specific information 223. That is, BNPL product provider 230 will place the user specific information 223 provided by the user specific information engine 220 into the forms that are provided to the customer's mobile device. By populating the forms prior to presenting them to the customer, the abandonment rate will be improved as the application process will be shortened due to the pre-filling of the customer's information into the application forms.

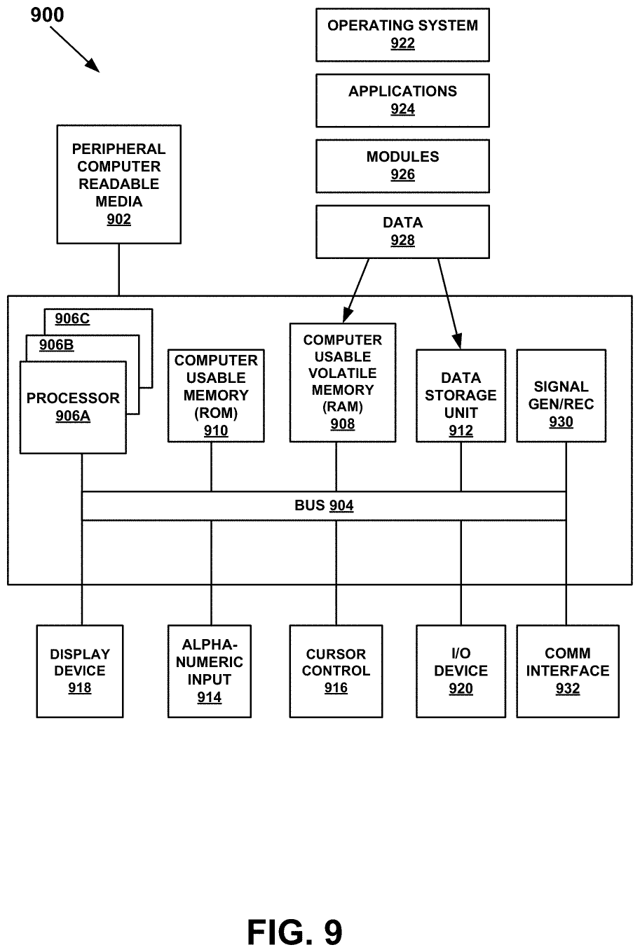

In one embodiment, BNPL product provider 230 and/or BNPL producer 360 are computing systems similar to computer system 900 described in detail in the FIG. 9 discussion herein. In one embodiment, BNPL producer 360 includes a customer account identifier 261, a BNPL product builder 262, a token generator 263, and a BNPL product generator 265.

In one embodiment, once the customer completes the new BNPL product pass 170 application, BNPL producer 360 will receive the information for the new BNPL product pass 170 application from credit screener 240.

In one embodiment customer account identifier 261 accesses database 227 which stores a plurality of customer credit accounts and utilizes the user specific information 223 in order to identify any accounts related to the customer. In one embodiment, customer account identifier 261 accesses database 227 via cloud 226. An example of cloud 226 is a network such as the Internet, LAN, WAN, or the like. Database 227 may include store specific data, brand specific data, retailer specific data, a shared database, a conglomerate database, a portion of a larger storage database, and the like. Moreover, database 227 could be a local database, a virtual database, a cloud database, a plurality of databases, or a combination thereof.

In one embodiment, database 227 stores a plurality of customer credit accounts, a plurality of customer reward accounts and/or offers, coupons, and the like. Customer account identifier 261 searches database 227 for one or more customer accounts (e.g., credit accounts, reward accounts, and/or offers, coupons, and the like) that are held by the identified customer. When any customer credit accounts are found, they are provided by the customer account identifier 261 to BNPL product builder 262 which links the one or more customer accounts with the BNPL product pass 170 information to build a customer data file.

Token generator 263 then generates a token identifying the customer data file. In one embodiment the token is an identification number, hash, or other type of anti-tamper encrypted protection that is generated as an identifier for the customer data file.

BNPL product generator 265 generates a BNPL product pass 170 formatted for mobile wallet 129. In one embodiment, the BNPL product pass 170 could include an image and a token embedded within the image data. For example, the token could be provided via NFC between the mobile device 110 and the POS when BNPL product pass 170 is presented at the POS 104. In another embodiment, there is no token and some or all of the metadata content of the BNPL product pass 170 is provided at the POS (or other checkout method) at the time of the transaction. In one embodiment, metadata within BNPL product pass 170 includes an instruction that causes the BNPL product pass 170 to be placed in a first location of mobile wallet 129 on the customer's mobile device 110.

In one embodiment, once the BNPL product pass 170 is added to mobile wallet 129 on the customer's mobile device 110, an access of the mobile wallet causes the BNPL product pass 170 to be presented on the display 112 of the customer's mobile device 110. In one embodiment, the presentation of BNPL product pass 170 by the customer's mobile device 110 could be audible, visual, or the like, to provide payment at the time of a customer purchase as described herein.

In one embodiment, BNPL product pass 170 is available to be used as a form of payment as soon as it is received in the mobile wallet 129. Additional details regarding the digital credit account identifier are shown and described with reference to FIGS. 6A through 6F herein.

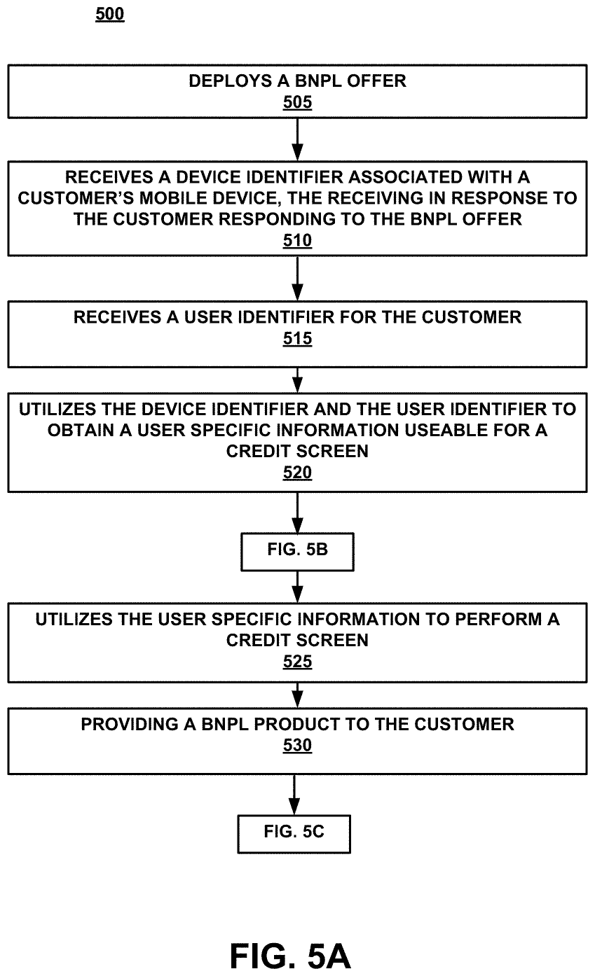

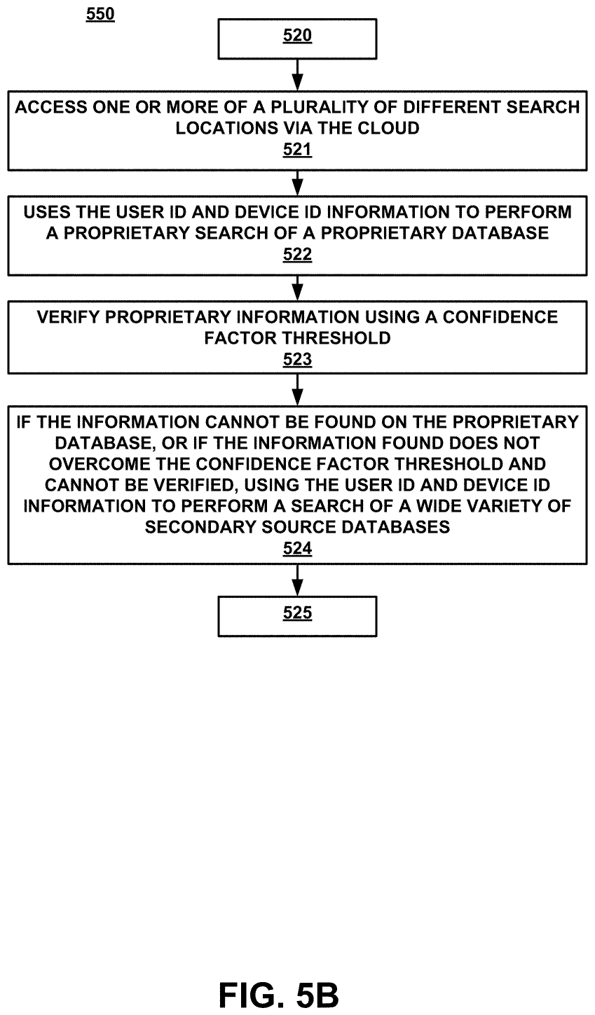

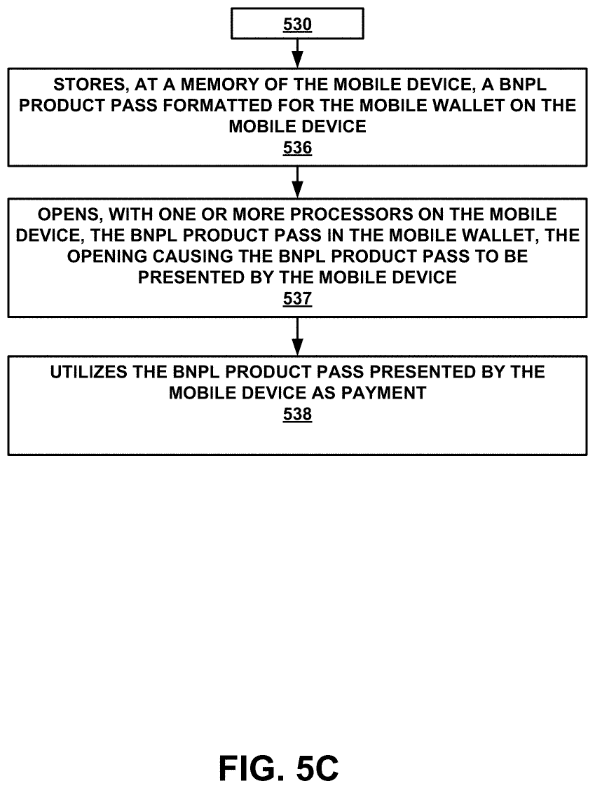

With reference now to FIG. 5A, a flowchart 500 of a method for providing a BNPL product to a credit account holder is shown in accordance with an embodiment. FIGS. 6A through 6F are also utilized to provide clarity and support for the discussion of flowchart 500.

In one embodiment, the BNPL offer 105 is advertised in the store so the customer can be made aware of the BNPL product prior to reaching the POS to provide a “basket lift”. For example, in a suit section of a store, there may be a poster (or associate provided information) that lets the customer know that instead of purchasing one suit today, they could purchase three suits and pay them off over time using the BNPL product. Thus, in one embodiment, the customer could pick up a few additional items (or a more expensive item) with the goal of using the BNPL product at the checkout.

Flowchart 500 provides a BNPL application experience that works in a similar fashion regardless of whether the BNPL application experience is occurring on a mobile device, on a computing device, or via a combination of both the mobile device and the computing device. For example, the application experience could be handed off from the customer's mobile device to a home/work computing device, or from the computing device to the customer's mobile device.

In one embodiment, the customer accesses the BNPL application system via a mobile web. The application system can determine via device detection, if the customer began the application process from a mobile device or if the customer began the application process on a computing device.

FIG. 6A is a block diagram of a BNPL offer 105 shown in accordance with an embodiment. FIG. 6B is a screen capture 610 of a BNPL application including a customer's credit account information 611, the BNPL product information including payment option terms and/or conditions 612, and an apply or place order 615 input, as viewed on a customer's mobile device 110 in accordance with an embodiment. FIG. 6C is a screen capture 620 of the BNPL application requesting a verification code 621 as viewed on a customer's mobile device 110 shown in accordance with an embodiment. FIG. 6D is a screen capture 630 of the identified customer's BNPL product 631 information and a ready for purchase feature such as code 632 (which may be a visual code, an aural code, and/or a combination thereof) as viewed on a customer's mobile device 110 shown in accordance with an embodiment. FIG. 6E is a front view of an embodiment of a retail transaction computing system 640 located at store 100 shown in accordance with an embodiment. FIG. 6F is a screen capture 650 of a confirmation message 651 that the BNPL product 631 has been used to make a transaction as viewed on a customer's mobile device 110 shown in accordance with an embodiment. Although a number of different pages are shown, it should be appreciated that the pages could be combined, reordered, skipped, more pages added, or the like. The use of FIGS. 6A-6F is one embodiment, that provides clarity for the discussion.

Although the interactions between a customer's mobile devices and the BNPL application are shown in the format of text messages and screen captures, it should be appreciated that the interactions may be made via one or more of: a beacon broadcast, WiFi broadcast, email, text, SMS, social media alert, app alert, or the like.

With reference now to 505 of FIG. 5A, one embodiment deploys a BNPL offer 105.

For example, as shown in FIG. 6A, in one embodiment, BNPL offer 105 includes signage that can include details about the BNPL product payment plan 601, signage about how to interact 602 with the BNPL offer 105, and a capturable code 603.

As stated herein, BNPL is a payment product that does not establish a new credit account. In other words, there is no new credit product being opened. Instead, an existing account such as a debit card, a bank card, a bank account, another credit account, or the like is used to perform the transaction.

In one embodiment, the process will begin with a customer's mobile device 110 interacting with the BNPL offer 105. The BNPL offer 105 can be in-store, on-line, or the like. In-store examples of the BNPL offer 105 could be a visual presentation such as a poster or other media on a wall in the store 100, a tri-fold or other media by the POS 104, displayed on a screen in the store, printed on the floor, etched in the glass, part of a sticker, etc. In one embodiment, the BNPL offer 105 could be presented/provided electronically such as via a display screen, displayed on an associate's tablet or other mobile device, received at a customer's mobile device 110 via NFC, beacon, WiFi broadcast, RFID broadcast, or the like.

On-line examples include the BNPL offer 105 displayed on a webpage, in an app (such as a downloaded app, a web-based app, a hybridized app e.g., partially downloaded and partially web based), and the like.

In one embodiment, the BNPL offer 105 includes a visual and/or an aural capturable code 603. In one embodiment, the capturable code 603 will be one or more of a visual and/or an aural capturable code 603 such as a 1D code, 2D code, a barcode, UPC, matrix barcode, QR code, Micro QR code, IQR code, SQR code, Frame QR code, HCC2D code, SPARQCode, JAB code, PDF 417, SnapTag, Aztec code, 3D code, a sound code such as Touchatag, TikiTag, etc., a picture code, a video code, or the like.

In one embodiment, the interaction between the customer's mobile device 110 and the BNPL offer 105 is initiated by the customer's mobile device 110 interacting with the capturable code 603 feature which could be a poster, display screen, text link, URL, NFC, beacon, WiFi broadcast, RFID broadcast, or the like. Thus, the capturable code 603 may be captured with a camera, a microphone, radio receiver, or other capture capability on the customer's mobile device 110.

With reference now to 510 of FIG. 5A, one embodiment receives a device identifier associated with a customer's mobile device 110. As stated herein, device ID 216 can be different depending upon the device. In one embodiment, device ID 216 that is requested for the process is based upon an evaluation of which of the possible device IDs would provide the best capability for fraud prevention. For example, a customer's mobile number could be easily obtained (e.g., via social media, public records, white pages, Internet search, etc.) so it would be a lower device ID option on a fraud scale. In contrast, the customer's mobile device serial number, MEI, ICCID, MEID, SEID, or the like is much less likely to be obtained fraudulently (via social media, public records, guessed, etc.) so it may be that one of the IMEI, ICCID, MEID, SEID, or the like would be the device ID with the highest fraud prevention value

With reference now to 515 of FIG. 5A, one embodiment receives a user identifier for the customer. User ID 218 can be the customer's identification information that was provided in FIG. 6A. In one embodiment, the user ID 218 that is requested on the page displayed in FIG. 6A is based upon an evaluation of which of the possible user IDs would provide the best capability for fraud prevention. For example, a customer's birthday could be easily obtained (e.g., via social media, public records, etc.) so it would be a lower user ID option on a fraud scale. Similarly, a customer's address could be easily obtained (e.g., via social media, public records, etc.) so it would also be a lower user ID option on a fraud scale. Further, a customer's email could be easily obtained (e.g., via social media, public records, etc.) or easily guessed, so it would also be a lower user ID option on a fraud scale. In contrast, a social security number (or last four, six, seven, five, middle three, five, first 6, 7; middle three+last two; or any other amount or combination of the nine social security numbers) is much less likely to be obtained fraudulently (e.g., via social media, public records, guessed, etc.) so it may be that a pre-selected portion of the SSN (or a changing selected portion of the SSN) would be the user ID with the highest fraud prevention value.

For example, referring to FIG. 6A and FIGS. 1 and 2, the result of the customer's mobile device 110 interacting with the BNPL offer 105 is the generation of an electronic message (e.g., a text message, email, etc.) that is formatted and addressed (e.g., a text number or other short code) to deliver the electronic message to BNPL product provider 230. By having the interaction between the BNPL offer 105 and the customer's mobile device causing the customer's mobile device 110 to automatically generate and format the electronic message, the customer is saved the time required to open and address the electronic message. Moreover, any accidental transcribing or other clerical errors will be reduced/removed since the customer is not keying in the formatted information (e.g., BNPL product provider 230 contact information, short code, text number, or the like).

In one embodiment, since the electronic message is formatted from instructions provided during the customer's mobile device 110 interaction with the BNPL offer 105, the initial generated electronic message will include whatever information was predefined to be obtained by the BNPL offer 105 as deployed by BNPL product provider 230. Such information could include a request for customer ID information, a request for device ID information, a generation of metadata associated with the electronic message that includes device ID information, location information, customer ID information, customer credit account information, etc.

In one embodiment, the automatic generation of the electronic message from the interaction with the BNPL offer 105 could include automatic insertion of one or more pieces of customer or device information, a request for authorization to send an email with the automatically inserted information, a request for manual input of one or more of the pieces of information, a combination of automatic and manually input information, or the like.

In one embodiment, BNPL product provider 230 will leverage the customer identification system 200 to obtain and/or validate the identity of the customer and prefill name, address, and email to set up a BNPL account.

With reference now to 520 of FIG. 5A and as shown and expanded in the flowchart 550 of FIG. 5B and shown in FIGS. 3 and 4, one embodiment utilizes device ID 216 and user ID 218 to obtain user specific information 223 useable for a credit screen and/or to prepopulate the BNPL application. In general, user specific information 223 could be one or more of: a name and full or partial address, a driver's license number, a social security number, an existing credit account, or the like.

At 521 of FIG. 5B, user specific information engine 220 may access one or more of a plurality of different search locations via the cloud 226. At 522 of FIG. 5B, one embodiment uses the device ID 216 and user ID 218 information to perform a proprietary search 5 of a proprietary database 16. At 523 of FIG. 5B, in one embodiment, user specific information 223 that is found in the proprietary database 16 will be verified using a confidence factor threshold. At 524 of FIG. 5B, if the user specific information 223 cannot be found on the proprietary database, or if the user specific information 223 found does not overcome the confidence factor threshold, one embodiment uses the user ID 218 and device ID 216 information to perform a search of a secondary source database 26. In one embodiment the user specific information 223 is provided via return information 12 to user specific information engine 220 and then passed on to BNPL product provider 230 as discussed herein and shown in FIGS. 3 and 4. In one embodiment, if no user specific information 223 is found by second source search engine 28, or if the user specific information 223 found does not reach the threshold of the confidence factor, the user specific information engine 220 will receive a return empty 39. At 525 of FIG. 5A, one embodiment utilizes user specific information 223 to perform a credit screening.

With reference now to FIG. 6B, a screen capture 610 of a BNPL application including a customer's credit account information 611, the BNPL product information including payment option terms and/or conditions 612, and an apply or place order 615 input, as viewed on a customer's mobile device 110 is shown in accordance with an embodiment.

In one embodiment, the BNPL application information is pre-filled with the information obtained by user specific information engine 220 and presented to the customer. In one embodiment, the customer can confirm that the information is correct, and that information will then be used by BNPL product provider 230 to generate the BNPL product. Thus, instead of having to type in the information, the customer would simply verify that the information is correct and make any changes accordingly. Similarly, if some of the information was missing, the customer would be able to fill in only the missing portions without having to complete the entire form. Thus, the customer would see a significant reduction in the number of keystrokes for the pre-filled forms which would increase throughput, and decrease frustration and the time needed to fill out the forms.

In one embodiment, the customer identifies the account, e.g., customer's credit account information 611, to be used to obtain payments therefrom for the BNPL product. In one embodiment, when the customer has a number of existing accounts (such as a co-brand credit account, a PLCC account, a UPLCC account, an installment loan, or the like), the customer will have the option to select/elect which account will be used. In one embodiment, when the customer has a number of existing accounts (such as a co-brand credit account, a PLCC account, a UPLCC account, an installment loan, or the like), the BNPL producer 360 will automatically select/elect which account will be used.

In the case of the plurality of existing customer accounts, once the customer account is identified, the customer's credit account information 611 to be used to obtain payments therefrom will come from the customer identified account.

In one embodiment, BNPL product information including payment option terms and/or conditions 612 describes the payment plan that is established and agreed upon by the customer. In one embodiment, the BNPL product information including payment option terms and/or conditions 612 will take an initial payment at the time of the transaction, and then the rest of the payments for the purchase are automatically taken out as installment payments from the initial account provided based on the customer accepted terms in the BNPL agreement.

In one embodiment, included in BNPL product information including payment option terms and/or conditions 612 is an autopayment scenario. In one embodiment, the autopayment will be prefilled by the system using the customer's credit account information 611. For example, the offer would be to obtain the BNPL product and make the payments automatically from the customer's credit account. If the customer does not want to set up the autopay, then in one embodiment, the BNPL application process is stopped and no BNPL product is obtained.

In one embodiment, the autopayment scenario is not a requirement. This could be based on a customer's credit score, risk factors, or the like. For example, if the customer has a credit score that is higher than a pre-defined threshold, the autopayment is not a requirement, such that if the customer chooses not to join an autopayment process, the ability to continue the BNPL application process is not interrupted.

In one embodiment, if the customer has a credit score that is higher than a pre-defined threshold, the autopayment scenario could include an opportunity for a discount or reward if the customer selects the autopayment scenario. For example, the customer could receive an extended no interest grace period, a reduction of any associated fees, a reduced interest rate, or the like.

For example, a customer wants to purchase a watch for 400 dollars. At the time of checkout, the customer will select the BNPL product for payment. In one embodiment, the BNPL product will allow them to pay a percentage now and then have the remaining payments withdrawn from (or charged to) their account at the predefined and agreed upon payment schedule.

In one embodiment, the due at transaction time percentage can be a specific amount, e.g., 25% for example, or it could be based on the purchase price and the total number of monthly payments. For example, if the transaction is 500 dollars, the customer could choose a BNPL product with 5 equal payments such that the first payment due at time of purchase is 100 dollars and then there will be four additional payments taken out at the agreed upon payment schedule.

In one embodiment, the payment schedule can be a monthly schedule, weekly schedule, bi-weekly schedule, etc. For example, if the customer is paid every two weeks, the customer may choose a BNPL product with a payment schedule that includes a payment every two weeks after the date of their paycheck being received. In another embodiment, regardless of when the customer is paid, the customer may choose a payment schedule that includes a payment once a month.

In one embodiment, the BNPL product includes a number of options such as payment amount per payment and the payment timeframe. For example, if the customer is looking at making a 500-dollar transaction, they could be offered a BNPL1 that is 5 monthly payments of 100 dollars, BNPL2 that is 10 monthly payments of 50 dollars, BNPLX that is 50% due at transaction and then some number of weekly, bi-weekly, or monthly payments to cover the remaining 250 dollars.

In one embodiment, one or more different BNPL product options are presented to the customer as one or more payment scenarios. In other words, the BNPL product can be offered to the customer with a number of different payment scenarios such that the customer can select the payment amount and schedule, and use the BNPL product with the appropriate terms to complete the transaction. E.g., one or more optional payback schedules including amounts, number of payments, different interest rates, available offers, discounts, and the like.

In one embodiment, the BNPL product could include an incentive that will cause the customer to use the BNPL product instead of using an existing credit account or installment loan option. In one embodiment, the incentive could be a discounted interest rate, a coupon, an offer for a service, etc.

In one embodiment, the BNPL product is offered prior to the customer reaching the checkout. In so doing, when receiving the BNPL product, the customer may be inclined to spend (e.g., fill a cart with one or a number of products) an amount that is up to the BNPL offered amount. As such, the customer would be comfortable to take the product (or products) to checkout in person or on-line, knowing that they had been provided with a BNPL product that would cover the purchase amount they have in their cart.

In one embodiment, as stated herein, the different transaction payment scenarios may include different offers dependent upon the customer's credit history. For example, a customer with a good credit history could be offered a BNPL product that has a no interest plan. Similarly, depending upon the goals of the BNPL product provider 230, the BNPL product provider 230 may decide to weigh the BNPL product with respect to the existing customer credit account in order to drive one or more different customers toward the BNPL product. In one embodiment, the weighing may be based upon a customer's credit history, a brand or retailer's desires, available incentives, and the like.

In one embodiment, if the customer previously had a BNPL product, the customer may provide or identify one or more existing co-branded credit account, PLCC credit account, installment loan, etc.

In one embodiment, once the customer 101 identifies their account (or selects the specific account from the plurality of accounts they want to use to back the BNPL), in one embodiment, they will also have access to one or more previously used BNPL products. From this, the customer 101 can decide if they would want to pay for the transaction with the existing co-branded and/or PLCC credit account or apply for/utilize another BNPL product. In one embodiment, if the customer chooses to use another BNPL product, in one embodiment, they will continue through the process shown in FIGS. 6C-6E to obtain a new BNPL product for making a new transaction.

Once the customer has verified the information on the BNPL application, the customer will select the apply or place order 615 input to provide the BNPL application to BNPL product provider 230. In one embodiment, apply or place order 615 input includes a signature (or electronic signature) portion.

In one embodiment, after the customer selects the apply or place order 615 input to provide the BNPL application to BNPL product provider 230, a verification is sent. For example, as shown in FIG. 6C, a screen capture 620 of the BNPL application requesting a verification code 621 as viewed on a customer's mobile device 110 is shown in accordance with an embodiment.

In one embodiment, BNPL product information including payment option terms and/or conditions 612 will include an optional opportunity for the customer to change the terms and conditions, interest rate, any grace period information, the breakdown of payments, and the like.

If the customer chooses to review the opportunities offered by the optional changes to the BNPL product information including payment option terms and/or conditions 612, the customer will move to the modify one or more aspects thereof. For example, the customer will be able to review offers, additional fees, additional opportunities, and the like available by selecting a non-default monthly payment amount (or length of the BNPL product payback schedule).

For example, the customer could receive a discount for a reduced BNPL product term. That is, the customer has the opportunity to pay off the BNPL product within a time period that is shorter than the default time period. For example, if the customer pays off the BNPL product in 2 months, there would be no interest charged and the BNPL product fee would be reduced to 5 dollars. If that opportunity is accepted, the amount of the BNPL product would be 505 dollars (e.g., 500 dollars+5-dollar fee) broken down over 2 months thereby resulting in a monthly payment of 252.50 per month for the next 2 months.

If the customer accepts the reduced term and conditions and any additional terms and conditions that are included therewith, then the customer will select the apply or place order 615 input. In one embodiment, instead of obtaining a discount by reducing the BNPL product term, the customer could select to modify the payment options by extending the BNPL product term and obtain a reduced monthly payment amount. In one embodiment, extending the BNPL product term will also result in a larger cost than the cost included in the BNPL product information, including payment option terms and/or conditions 612.

In one embodiment, a reduced monthly payment amount, will provide a limit as to the longest allowable term, have a predefined minimum monthly payment amount, or the like. In one embodiment, the reduced monthly payment amount could provide a BNPL product term range, a minimum monthly payment range, or the like. In one embodiment, when the customer looks at the different options, the appropriate BNPL product fee will be incorporated into the BNPL product information including payment option terms and/or conditions 612.

For example, if the customer would like to make monthly payments of 50 dollars toward the BNPL product, the customer would select the 50-dollar payment option and the modified BNPL product information including payment option terms and/or conditions 612 would be presented to the customer. In one embodiment, when the customer chooses to pay 50 dollars a month toward the BNPL product, the BNPL product fee would be increased by a defined amount and presented to the customer along with the terms and conditions. For example, the amount of the one-time BNPL product would be 520 dollars (e.g., 500 dollars+10-dollar fee+10 dollars in interest). Since the customer has selected to pay 50 dollars a month, the customer's BNPL product term would be 11 months, with 10 months of 50-dollar payments and the 11th month being a 20-dollar payment.

If the customer accepts the modified BNPL product information including payment option terms and/or conditions 612, then the customer will select the apply or place order 615 input.

Similarly, if the customer would like to make 10 monthly payments on the BNPL product, the customer would select the 10 month payment option and the modified BNPL product information including payment option terms and/or conditions 612 will be presented to the customer. In one embodiment, when the customer chooses to pay back the BNPL product over a selected number of month that are longer than the default number of months, the BNPL product fee would be increased by a defined amount and presented to the customer along with the terms and conditions. For example, the amount of the one-time BNPL product would be 520 dollars (e.g., 500 dollars+10-dollar fee+10 dollars in interest). Since the customer has selected a BNPL product term of 10 months, the monthly payment would be 52 dollars per month.

If the customer accepts the modified BNPL product information including payment option terms and/or conditions 612, then the customer will select the apply or place order 615 input.

With reference now to 530 of FIG. 5A, once the customer passes the credit screening, one embodiment provides the BNPL product pass 170 to the customer. For example, at FIG. 6D, an embodiment of a screen capture 630 of the identified customer's BNPL product 631 information and a ready for purchase feature such as code 632 (which may be a visual code, an aural code, and/or a combination thereof) as viewed on a customer's mobile device 110 is shown in accordance with an embodiment.

In one embodiment, BNPL product pass 170 includes description information that is recognizable by the customer such as the BNPL product 631 account information and code 632. In one embodiment, the BNPL product 631 account information could include aspects such as, the customer's name, account number, BNPL monetary value, reward information, and the like.

In one embodiment, code 632 is a scannable code such as described herein. In one embodiment, code 632 can include a static or dynamic image. For example, if the code 632 is a static image, the code 632 would be the same (or change only when updated) each time the BNPL product 631 and/or BNPL product pass 170 was opened. The code 632 would include static information such as customer identifiers, account identifiers, device identifiers, autofill formatted ID information, or the like which would not be subject to changing very often (e.g., other than system updates, etc.).

In contrast, if the code 632 is dynamic, code 632 could be changed (or adjusted) each time the BNPL product 631 and/or BNPL product pass 170 is opened by the customer (or at a given time period, any time a change to the stored information occurs, etc.).

In one embodiment, the dynamic code 632 is requested from the BNPL product provider 230 each time the BNPL product 631 and/or BNPL product pass 170 is accessed. That is, the code 632 would be provided from BNPL product provider 230 at the time of opening to ensure that code 632 on the BNPL product 631 and/or BNPL product pass 170 is real-time and up-to-date.

In one embodiment, screen capture 630 also includes an optional action button 633 (or the like) to add, or send, the BNPL product 631 to the customer's mobile wallet 129 as a BNPL product pass 170.

FIG. 5C is a flow diagram 575 of a method for utilizing a BNPL product pass 170 in mobile wallet 129 of a mobile device 110 to make a transaction, in accordance with an embodiment.

Referring now to 536 of FIG. 5C, one embodiment stores, at a memory of the mobile device 110, the BNPL product pass 170 formatted for the mobile wallet 129 on the mobile device 110. In one embodiment, once the BNPL product pass 170 is received at the mobile wallet 129 on the customer's mobile device 110, it is instantly available to be used as a form of payment.

In one embodiment, the BNPL product pass 170 includes a token. In one embodiment, the token embedded in code 632 will also be added to the BNPL product pass 170 stored in mobile wallet 129.

In one embodiment, since the BNPL product pass 170 will be stored as a pass instead of a payment instrument (e.g., stored as a credit card, bank account, etc.) within mobile wallet 129, BNPL product provider 230 (and/or retailer) will have the capability to remotely change the code 632 and/or the token embedded in code 632 on the pass without needing to notify the customer or obtain permission from the customer. Instead, access to BNPL product pass 170 by BNPL product provider 230 (and/or retailer) will be used based on business rules to manage fraud and risk.

In so doing, BNPL product pass 170 will be the first in the field of shopping passes for mobile wallets that will be leveraged as a completely secure and tokenized solution for payment and without exposing a card number in the bar code.

Thus, in one embodiment, by putting a tokenized BNPL product pass 170 into a non-payment type portion of the mobile wallet 129, that is, by not storing the BNPL product pass 170 as a payment pass but instead storing it in a non-payment section of the mobile wallet that can include other less secure items such as rewards, a boarding pass, a parking pass, etc., the non-payment storage section will allow the BNPL product pass 170 to be adjusted, modified, and/or interacted with under a lot less security than payment vehicles stored in the more secure payment vehicle section of mobile wallet 129.

In one embodiment, the BNPL product pass 170 is stored as a payment vehicle in the more secure payment vehicle section of mobile wallet 129 and, as such, it is not as easily modifiable.

With reference now to 537 of FIG. 5C, one embodiment opens, with one or more processors on the mobile device 110, the BNPL product pass 170 in mobile wallet 129. The opening causes the BNPL product pass 170 to be presented by the mobile device 110. For example, after the BNPL product pass 170 is added to the customer's mobile wallet 129, BNPL product pass 170 would be accessible in the mobile wallet in the same way that any other items are accessed by mobile wallet 129. In one embodiment, the BNPL product pass 170 could also include metadata information that would make sure that the BNPL product pass 170 opens on the top of the mobile wallet stack. For example, when the customer opened the mobile wallet 129 application, BNPL product pass 170 would be the first in the stack that could include other payment cards, tickets, etc.

With reference now to 538 of FIG. 5C, one embodiment utilizes the BNPL product pass 170 and (in one embodiment, the token) presented by the mobile device 110 as payment at a point-of-purchase, POS 104, associates mobile checkout device, Web-site checkout, on-line checkout, etc. For example, referring to FIG. 6E, a front view of an embodiment of a retail transaction computing system 640 located at store 100 is shown in accordance with an embodiment.

Although the discussion uses one embodiment of the BNPL product pass 170 being presented to the retail transaction computing system 640, it should be appreciated that the BNPL product pass 170 could be presented to a beacon (or other wireless communicator) as part of an automated check-out process. In one embodiment, the BNPL product pass 170 could be presented (visually and or aurally) to a store associates' mobile device as part of a mobile checkout scenario. In one embodiment, the BNPL product pass 170 could be presented digitally to a website for on-line payment, and the like.

For example, the presentation of part or all of the BNPL product pass 170 could be visual (e.g., an image on the display screen), electronic radio signal (e.g., an NFC, Bluetooth, or similar electronic communications protocol), an audible sound, a combination thereof, or the like.

In one embodiment, when the customer goes to a shop and during checkout intends to use the BNPL product pass 170, the customer would present BNPL product pass 170 to the retail transaction computing system 640 (or the POS, another checkout system such as an associate's mobile device, etc.).

In one embodiment, as described herein, the token is embedded within code 632 and will be passed to the retail transaction computing system 640 and recognized by BNPL product provider 230 to return an approval on the BNPL transaction.

For example, when BNPL product pass 170 is presented at checkout it could include the transmission of the token via NFC, a scan of the BNPL product pass 170 code 632, etc. In general, since the BNPL product pass 170 has already been validated, the token would be provided in conjunction with the information. In one embodiment, the information from the BNPL product pass 170 (e.g., token, metadata, visual code, and/or the like) would be received at the POS 104 (or other checkout option) and then provided to the BNPL provider to validate the transaction and link the BNPL purchase to the appropriate customer's credit account. The BNPL provider would then provide the authorization for the purchase to the POS and the transaction would be completed.

In one embodiment, the transaction could also include information from the device such as customer biometric information, location information (e.g., provided by GPS 118), the transaction time, the transaction date, etc. In one embodiment, the location information provided by the mobile device 110 will include time and date stamp information. In another embodiment, the location, time and/or date could be obtained from the POS 104, a combination of the customer's mobile device 110 and the POS 104, etc.

In one embodiment, for the transaction to occur, BNPL product pass 170 would be validated using the internet connection from the POS 104, the biometric information for the customer (as provided via a token or the like) from the customer's mobile device 110, the location obtained from GPS 118, the time, the date of the transaction initiation, the mobile device identification number, etc.

In so doing, the security of the customer's BNPL product pass 170 payment would be seamless and nearly instantaneous to the customer and the associate handling the transaction, but would include a plurality of checks and balances performed by the BNPL product provider, the brand, or a fraud evaluator assigned to make fraud mitigation determinations and/or evaluations.

With reference now to FIG. 6F, a screen capture 650 of a confirmation message 651 that the BNPL product 631 has been used to make a transaction as viewed on a customer's mobile device 110 is shown in accordance with an embodiment.

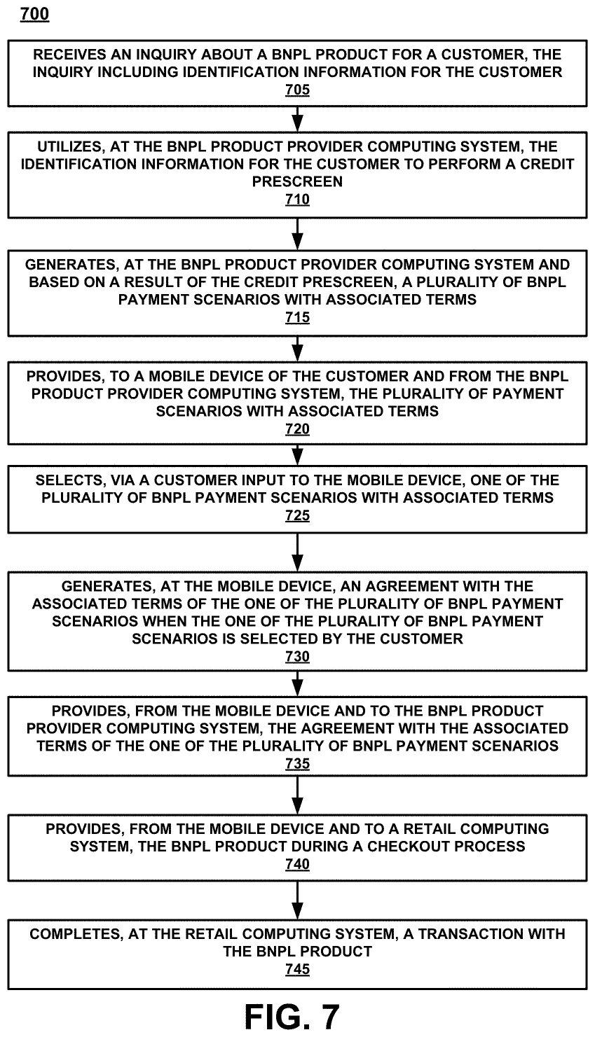

Referring now to FIG. 7, a flowchart 700 of a method for providing a customer 101 with a BNPL product is described, in accordance with an embodiment.

At 705, one embodiment receives an inquiry about a BNPL product for a customer 101, the inquiry including identification information for the customer. In one embodiment, the inquiry is initiated when the customer interacts with BNPL offer 105 (of FIG. 1) which may be provided by the entrance 102 to store 100, in a section of the store such as a furniture, clothing, shoes or the like. As described herein, in one embodiment BNPL offer 105 may be presented on a physical item such as a poster, or the like and include a visual code such as a barcode, QR code, or the like. As such, BNPL offer 105 may be scanned by the customer 101 with the customer's mobile device.

In one embodiment, BNPL offer 105 is provided via a beacon such as one or more of beacons 103-1 through 103-n. In another embodiment, BNPL offer 105 is provided by an application on the customer's mobile device 110 after the customer's mobile device 110 is determined to be in store 100, within range of beacon 103-1 and/or 103-n. In yet another embodiment, the offer is provided on the customer's mobile device 110 when a location capability of the customer's mobile device 110 determines that the customer 101 is located near store 100. In general, near store 100 refers to a location such as, within the bounds of the store, within a few yards of the store, within the mall in which store 100 is located, within a beacon or WiFi broadcast range of store 100, or within a block of store 100.

At 710, one embodiment utilizes, at the BNPL product provider 230 computing system, the identification information for the customer to perform a credit prescreen.

At 715, one embodiment generates, at the BNPL product provider 230 computing system and based on a result of the credit prescreen, a plurality of BNPL payment scenarios with associated terms.

In one embodiment, a purchase amount is received as part of the inquiry about the BNPL information for the customer. In one embodiment, if it is determined that the customer has or had previously obtained a BNPL product, the customer may also receive a number of different rewards, offers, interest rates, or the like that may vary with the different payment scenarios. In one embodiment, those different choices may be used to drive payment scenario utilization, be based on some underlying contract, goal, or requirement, be time-of-year dependent, and the like.

At 720, one embodiment provides, to mobile device 110 of the customer and from the BNPL product provider 230 computing system, the plurality of payment scenarios with associated terms. In one embodiment, such as internet shopping or on a mobile device 110 during a real-world shopping experience, the customer may be provided with tender reminder messages for either rewards or “pay as low as” messaging. E.g., “if you use a BNPL product you will be able to make the purchase while paying as low as 25 dollars a month for 6 months”.

In one embodiment, such as internet shopping or on a mobile device display 112 during a shopping experience, if a customer is declined for the BNPL product a message will be displayed on the mobile device 110.

At 725, one embodiment selects, via a customer input to the mobile device 110, one of the plurality of BNPL payment scenarios with associated terms.

At 730, one embodiment generates, at the mobile device 110, an agreement with the associated terms of the one of the plurality of BNPL payment scenarios when one of the plurality of BNPL payment scenarios is selected by the customer.

At 735, one embodiment provides, from the mobile device 110 and to the BNPL product provider 230 computing system, the agreement with the associated terms of the selected BNPL payment scenarios. In one embodiment, the associated terms include an interest rate, a reward information, a time period for repayment, a predefined payment amount, a recurring payment due date within the time period for repayment, and the like.

At 740, one embodiment provides, from the mobile device 110 and to a retail computing system, the BNPL product during a checkout process.

At 745, one embodiment completes, at the retail computing system, a transaction with the BNPL product. In one embodiment, the retail computing system will request a transaction authorization from the BNPL product provider 230 computing system during the checkout process. In one embodiment, the retail computing system will receive the transaction authorization from the BNPL product provider 230 computing system. Upon receipt of the transaction authorization at the retail computing system, the transaction will be completed with the BNPL product.

In one embodiment, the BNPL product, the selected payment scenario, and the associated terms is stored in a BNPL product provider 230 database upon receipt of a transaction completion confirmation from the retail computing system.

With reference now to FIG. 8A, a block diagram of a system for fraud detection is described in accordance with an embodiment. In general, system 800 includes a fraud determination module 805 which receives address information from the location information evaluator 804 which determines the address from the raw location information 803 provided by mobile device 110. System 800 also includes cloud 226 which may be any type of wired or wireless network connection including private, public, Local, Wide, Internet, and the like.

In one embodiment, fraud determination module 805 is a rules-based fraud determination engine that can change the weighting of risk factors, etc. For example, the BNPL application accessed from a non-phone computing device provides a first authentication (e.g., a non-phone computing device ID) and a user ID. The inclusion of a phone number in the BNPL application process allows for a second factor authentication (e.g., a mobile device ID). However, if the information provided in the BNPL application (e.g., the name, address, phone number, email, etc.) does not match, the fraud determination module can provide that a first weight. In another example, if the non-phone computing device is at a first location, and the second factor authentication (e.g., the mobile device) is in a different location (or a certain distance away from) the non-phone computing device, fraud determination module 805 can provide that a second weight that is different than the first weight.

In one embodiment, the user ID and/or the device ID information that is obtained can be used to evaluate for fraud. For example, the user ID that is provided to the application process is ranked or evaluated for its fraud potential. For example, 1 is the lowest fraud risk and 10 is the highest. If the customer's zip code is provided it may be ranked at a 7 out of 10 for fraud. In contrast, if the last 6 of the customer's SSN is provided it may be ranked at a 2 out of 10 for fraud.

Similarly, the device ID that is provided to the BNPL application process is ranked or evaluated for its fraud potential. For example, 1 is the lowest fraud risk and 10 is the highest. If the mobile number is provided, it may be ranked at a 5 out of 10 for fraud. In contrast, if the non-phone computing device UUID is provided, it may be ranked at a 2 out of 10 for fraud.

The fraud risk is then evaluated. The evaluation could be for one of the identifiers, both of the identifiers, or a combination of the identifiers. For example, in one embodiment when the fraud scale base is 10, the single identifier fraud risk would be evaluated as low if it is a 3 or below, medium if it is between 4-5, high if it is between 6-8, and unacceptable if it is 9 or above.

If both of the fraud rankings are added together the scale could remain the same or could be different. For example, the scale could remain the same, be doubled, have the range changed such that 15 (or whatever value is selected) is the new top range, etc. For example, the fraud risk for the combined value (using a top range of 15) would be evaluated as low if it is a 4 or below, medium if it is between 5-8, high if it is between 9-11, and unacceptable if it is 12 or above.

In another embodiment, the scale could be out of any number, e.g., 20, 50, 100, etc. depending upon the desired granularity. In one embodiment, there could be an additional level of granularity if the resultant fraud risk was at a certain level (e.g., a 6 could cause additional evaluation to determine a finer granularity of 6.3 or 6.6).

In one embodiment the result of the fraud risk determination controls at least one aspect of the BNPL product pass 170. For example, if the fraud risk determination result is low, the fraud determination does not interfere with the monetary value of the BNPL product.

In contrast, when the result of the fraud risk determination is medium, the monetary value of the BNPL product may be reduced (for example the customer would qualify for a monetary value A, the monetary value would be reduced by fraud risk amount (or percentage, or the like) B, resulting in an initial monetary value of A-B (or A reduced by B %, or the like). Similarly, when the result of the fraud risk determination is high, the monetary value for the BNPL product is again reduced based on the fraud risk.

In one embodiment, if the fraud risk determination is unacceptable, the BNPL application process will deny the customer from receiving the BNPL product. In one embodiment, if the fraud risk determination is unacceptable the BNPL application process will deny the customer from continuing the application process for the BNPL product. In one embodiment, if the fraud risk determination is unacceptable, the application process will not provide any automatic prefilling of the BNPL application and flag the application.

Consider the following example for purpose of clarity. In the following examples, the scale for a single risk factor is 10 and the combination of risk factors is 15.

A. The customer's zip code is provided and is ranked at a 9, e.g., an unacceptable fraud risk.

B. The last 4 of the customer's SSN is provided and is ranked at a 2, e.g., a low fraud risk.

C. The mobile number is provided and is ranked at a 5, e.g., a medium fraud risk. D. The non-phone computing device UUID is provided and is ranked at a 2, e.g., a low fraud risk.

Example 1. If user ID ‘A’ (risk level 9) and device ID ‘C’ (risk level 5) were provided, the fraud determination would be an unacceptable user ID fraud risk, and a medium device ID fraud risk. If the fraud determination was based on the highest single fraud determination, then the fraud determination would result in an unacceptable fraud risk. In one embodiment, this would stop the BNPL application process and the customer would be denied.

Example 2(A). If user ID ‘A’ (risk level 9) and device ID ‘C’ (risk level 5) were provided, the fraud determination would be an unacceptable user ID fraud risk, and a medium device ID fraud risk. In one embodiment, the application could request a second user ID ‘B’ (risk level 2). After the customer provided information user ID ‘B’, in one embodiment, the user ID fraud risk would become a risk level 2. If the fraud determination was based on the highest single fraud determination, then the fraud determination would result in medium fraud risk (risk level 5). In one embodiment, this would allow the BNPL application process to be completed but the customer would receive a BNPL product that may or may not be for a reduced monetary value.

Example 2(B). In one embodiment, the user ID and/or device ID is used during a look-up process for identifying the customer and obtaining customer information. The customer information would be the information necessary for completing the BNPL application. In one embodiment, user ID ‘A’ would be compared with the additional customer information. If user ID ‘A’ (risk level 9) correlates with the customer information, this could cause a further risk level reduction from the risk level 5 in example 2(A) to the low fraud risk level 4. In so doing, the customer would not receive a reduced monetary value BNPL product.

Example 3. If user ID ‘A’ (risk level 9) and device ID ‘C’ (risk level 5) were provided, the fraud determination would be an unacceptable user ID fraud risk, and a medium device ID fraud risk. If the fraud determination was based on an amalgamation of two or more of the fraud components, then (in one non-weighted embodiment) the fraud determination would result in a risk level 14 which would result in an unacceptable fraud risk. In one embodiment, this would stop the BNPL application process and the customer would be denied.

Example 4(A). If user ID ‘A’ (risk level 9) and device ID ‘C’ (risk level 5) were provided, the fraud determination would be an unacceptable user ID fraud risk, and a medium device ID fraud risk. In one embodiment, the BNPL product provider 230 could request a second device ID ‘D’ (risk level 2). After the customer provided information D, in one embodiment, the device ID fraud risk would become a risk level 2. If the fraud determination was based on an amalgamation of two or more of the fraud components, then (in one non-weighted embodiment) the fraud determination would result in a risk level 11 which would be a high fraud risk. In one embodiment, this would not allow the BNPL application process to be completed.

Example 4(B). In one embodiment, the user ID and/or device ID is used during a look-up process for identifying the user and obtaining customer information. The customer information would be the information necessary for completing the BNPL application. In one embodiment, device ID ‘C’ would be compared with the additional customer information. If device ID ‘C’ (risk level 5) correlates with the obtained customer information, this could cause a further risk level reduction from the high fraud risk level 11 in example 4(A) to the medium fraud risk level 8. In one embodiment, this would allow the BNPL application process to be completed but the customer would receive a BNPL product that may or may not have a reduced monetary value.

Example X. If user ID ‘A’ (risk level 9) and device ID ‘C’ (risk level 5) were provided, the fraud determination would be an unacceptable user ID fraud risk, and a medium device ID fraud risk. In one embodiment, the BNPL product provider 230 could request a second user ID ‘B’ (risk level 2). After the customer provided information user ID ‘B’, in one embodiment, the user ID fraud risk would become a risk level 2. In one embodiment, the BNPL product provider 230 could request a second device ID ‘D’ (risk level 2). After the customer provided information D, in one embodiment, the device ID fraud risk would become a risk level 2.

If the fraud determination was based on the highest single fraud determination, then the fraud determination would result in low fraud risk (risk level 2).

If the fraud determination was based on an amalgamation of two or more of the fraud components, then (in one non-weighted embodiment) the fraud determination would result in a risk level 4 which would also be a low fraud risk.

Further, the user ID and/or device ID is used during a look-up process for identifying the customer and obtaining customer information. In one embodiment, user ID ‘A’ and device ID ‘C’ would be compared with the obtained customer information. If user ID ‘A’ and device ID ‘C’ correlate with the obtained customer information, this would provide a further fraud risk level reduction. In contrast, if one or both of user ID ‘A’ and device ID ‘C’ did not correlate with the obtained customer information, this could result in an increase in the fraud risk level. In one embodiment, the increase could be to a next higher level. In one embodiment, the customer may be asked by BNPL product provider 230 about the lack of correlation.

In one embodiment, if one or both of user ID ‘A’ and device ID ‘C’ did not correlate with the obtained customer information, the non-correlated information could be manually or automatically evaluated to determine if the lack of correlation is due to a clerical, typographical, or accidental error. For example, if user ID ‘A’ did not correlate, it would be evaluated. If the customer input user ID ‘A’ was zip code 12855 and the obtained customer information is zip code 12255, it may be evaluated as a customer input error and no fraud risk escalation would be made. In contrast, if the customer input user ID ‘A’ was zip code 96896 and the obtained customer information is zip code 12255, it would be evaluated as a deceitful input and the fraud risk escalation would be made or additional fraud risk evaluations would occur.

Thus, the fraud determination could be set as the highest fraud ranking of the highest fraud component, it could be set as an amalgamation of two or more of the fraud components, it could be adjusted based on the following additional fraud determination factors, it could be set as a weighted value for one of the user ID versus the Device ID, e.g., the user ID ranking carries 20% weight and the device ID carries an 80% weight, etc. Of course, the weighting could be ID dependent, set to different values, or the like.

In addition to the device ID and user ID fraud determination discussed above, there could be additional fraud determination factors that are described below and can be used to modify the fraud risk determination.

After the customer is identified and the customer information is obtained, the customer information will be evaluated to determine if the customer's information in the account center has had recent changes to home address, email, phone number, etc. If a recent change has occurred, then additional fraud evaluation will occur.

For example, a static IP address correlated with a particular MAC address would have a low fraud risk. In contrast, a MAC address that changes with respect to a static IP address would have a higher fraud risk. In one embodiment, if the static IP address includes a certain number of different MAC addresses (e.g., more than 2, 5, 10, 20, etc.) then the fraud risk would be weighted based on the number of different MAC addresses received from the static IP address.

Known Fraudulent Address

In one embodiment, the location where the customer completed the BNPL application is determined by location information evaluator 804 from the location information 803 provided by the mobile device 110. The location information evaluator 804 would evaluate the real-time location information 803 and cross-reference the real-time location information 803 with the one or more different coordinate-to-address determination sources 817, to generate a likely address. Similar to above, if the accuracy of the location information is high enough, a complete address for where the customer completed the BNPL application will be obtained. If the accuracy of the location information is not high enough, then a general area for where the customer completed the BNPL application will be obtained.

In one embodiment, fraud determination module 805 will access a database 825 of known fraudulent addresses and compare the location where the BNPL application was completed with the known fraudulent addresses found in the database. Fraud determination module 805 will determine, based on the location comparison, whether the location where the BNPL application was completed is found in the database 825 of known fraudulent addresses. If the location where the BNPL application was completed is found in the database 825 of known fraudulent addresses the BNPL application will be denied. In contrast, if the location where the BNPL application was completed is not found in the database 825 of known fraudulent addresses, the BNPL application will pass the fraud determination and the BNPL application will be passed to BNPL product provider 230 which will evaluate the BNPL application and may issue a BNPL product pass 170.

If the location where the BNPL application was completed cannot be defined specifically enough to ensure that it is not a match for, or not found in, the addresses of database 825 of known fraudulent addresses, then the fraud determination module 805 will be able to make a number of choices. For example, if the general location where the BNPL application was completed is in an area that includes a threshold number (e.g., 4 within the same block, etc.) of known fraudulent addresses, fraud determination module 805 will deny 836 the BNPL application and no BNPL product will be issued. In contrast, if the general location where the BNPL application was completed is in an area that includes no known fraudulent addresses, fraud determination module 805 may pass the BNPL application to BNPL product provider 230 with a small fraud determination resulting in a suggestion that the BNPL product's monetary value be lowered accordingly. However, if the general location where the BNPL application was completed is in an area that includes less than a threshold number (e.g., 2 within the same block, etc.) of known fraudulent addresses, fraud determination module 805 may pass the BNPL application to BNPL product provider 230 with a medium fraud determination resulting in a suggestion that the BNPL product's monetary value be lowered significantly.

In one embodiment, lowering the BNPL product's monetary value may mean a reduction of 10-20% from what would have been the original BNPL product amount while lowered significantly would mean a reduction of 50-75% in the BNPL product amount. However, it should be appreciated that these percentages are one example. The risk aversion of the BNPL product provider 230 may cause an increase or decrease in the percentages and even turn the medium risk BNPL applications into rejections such that the BNPL product is denied 836.

In one embodiment, fraud determination module 805 will access a database 835 of previously used addresses and compare the location where the BNPL application was completed with the previously used addresses found in the database. Fraud determination module 805 will determine, based on the comparing, whether the location where the BNPL application was completed is found in the database 835 of previously used addresses.

If the location where the BNPL application was completed is not found in the database 835 of previously used addresses the BNPL application will pass the fraud determination and the application will be passed to BNPL product provider 230 which will evaluate the BNPL application and issue a BNPL product pass 170.

However, if the location where the BNPL application was completed is found in the database 835 of previously used addresses, fraud determination module will determine a type of residence at the location where the BNPL application was completed. In one embodiment, the type of residence may be found in the database 835 of previously used addresses. In another embodiment, fraud determination module 805 will receive additional information about the location from the one or more different coordinate-to-address determination sources 817 via location information evaluator 804. The additional information will be used to determine the type of residency.

Fraud determination module 805 will then make a risk assessment based on a result of the determination regarding the type of residence.

For example, if the location where the BNPL application was completed is found in the database 835 of previously used addresses and it is determined that the type of residence at that address is a single-family home, then the fraud determination module 805 will be able to make a number of choices. If the number of BNPL applications received from the previously used address exceeds a threshold number (e.g., 3 within the same single-family home) fraud determination module 805 will deny 836 the BNPL application and no BNPL product will be issued.

In contrast, if the number of applications received from the previously used address is less than a threshold number (e.g., 2 within the same single-family home) fraud determination module 805 may pass the BNPL application to BNPL product provider 230 with a low fraud determination resulting in a suggestion that the BNPL product's monetary value be reduced accordingly.

Similarly, if the location where the BNPL application was completed is found in the database 835 of previously used addresses and it is determined that the type of residence at that address is a multi-family home (e.g., condo, townhome, apartment building, etc.), then the fraud determination module 805 will determine the number of dwellings within the multi-family home. If the number of BNPL applications received from the previously used address exceeds a threshold number (e.g., 80% of the dwellings within the multi-family home) fraud determination module 805 will pass the BNPL application to BNPL product provider 230 with an intermediate fraud determination resulting in a suggestion that the BNPL product's monetary value be lowered accordingly.

In contrast, if the number of BNPL applications received from the previously used address is less than a threshold number (e.g., 80% of the dwellings within the multi-family home) fraud determination module 805 will pass the BNPL application to BNPL product provider 230 with a low fraud determination resulting in a suggestion that the BNPL product's monetary value be lowered accordingly.

In one embodiment, if the location where the BNPL application was completed cannot be defined specifically enough to ensure that it is not a match for, or not found in, the addresses of database 835 of previously used addresses, then the fraud determination module 805 would report that lack of fraud determination to BNPL product provider 230. In another embodiment, if the location where the BNPL application was completed cannot be defined specifically enough to ensure that it is not a match for, or not found in, the addresses of database 835 of previously used addresses, then the fraud determination module 805 would deny 836 the BNPL application and no BNPL product would be issued.

However, it should be appreciated that these solutions to the problem that occurs when the location where the BNPL application was completed cannot be defined specifically enough may be defined differently based on the risk aversion of the BNPL product provider 230. For example, the BNPL product provider 230 may provide specific guidance such as an increase or decrease in the percentages, turn the medium risk BNPL applications into a deny 836 such that no BNPL product is issued, or turn the rejections into some level of risk such that a BNPL product pass 170 is issued with a lower monetary value.

With reference now to FIG. 8B, a flowchart 850 of a method for using position location information to fraud check a BNPL application is shown in accordance with an embodiment.

With reference now to 851 of FIG. 8B, one embodiment obtains authorization for the BNPL product provider 230 to access location information 803 about the BNPL application.

With reference now to 852 of FIG. 8B, one embodiment receives, at the computer system location information 803 about the BNPL application. In one embodiment, the location information 803 generated by a positioning system tracking such as GPS 118 on the mobile device 110. In one embodiment, the positioning system is on the mobile device, and is one or more of, but is not limited to, GPS, WiFi, cellular service, beacon derived location determination, NFC ranges, Bluetooth range, and the like. In another embodiment, the positioning system is virtual, which means that the positioning system is not on the mobile device 110 but is an interface, such as a GPS chip interface, that functions with software or web applications allowing the location functionality to work outside of a traditionally defined mobile device 110 or BNPL application.

Because of the different positioning systems available on a mobile device, the location information 803 provided by one or more positioning systems on the mobile device 110 can include differing levels of accuracy. For example, a GPS enabled mobile device 110 can provide location information 803 that is accurate to within a few meters or less. In contrast, location information 803 derived from cellular service, beacon or WiFi location capabilities of mobile device 110 can provide a location radius or location area that may be within 10-50 meters or even larger. For example, the mobile device 110 being located within range of a beacon at ninth street, a Wi-Fi hot-spot at a given coffee shop, within range or a single cellular service tower, within an overlapping area of a number of cellular service towers, a combination of the above, and the like.

In one embodiment, included with the location information 803 would be a level of accuracy. For example, location information 803 may be identified as having a high level of accuracy (0-5 meters), a medium level of accuracy (6-20 meters), a low level of accuracy (>20 meters), or the like. Although a number of different accuracies are discussed, it should be appreciated that there may be more or fewer levels of accuracy associated with location information 803. Further, the ranges of the different levels of accuracy disclosed may also be different based on preference, guidelines, needs, and the like.

Additionally, location information 803 may be determined by the positioning system at constant intervals, at pre-assigned time periods, when location determination commands are received, based on the use of the mobile device 110, an application on the mobile device 110, when a change is noted by the positioning system, and the like. Further, location information 803 may be recorded in the memory of the mobile device every time a location determination is made by the positioning system, at constant intervals, at pre-assigned time periods, when location storage commands are received, when a change is noted in the location information 803, and the like. Likewise, the level of accuracy may be determined each time location information 803 is generated by the positioning system, only when the level of accuracy has changed, at certain intervals of location information 803 generation, or the like.

At 853, location information 803 includes historic location information stored in a memory of the mobile device. Historic location information refers to location information 803 that is not real-time location information. Historic location information will include a date/time stamp. The historic location information would allow the stored location information to be searched, sorted, and evaluated. In one embodiment, the historic location information includes all location information 803 stored on the memory of the mobile device 110. Historic location information may cover the entire period the customer has owned the mobile device. In another embodiment, the time range for the historic location information is limited. For example, the location data may only be obtained for a pre-defined time range, e.g., the past 2 years, 1 year, 6 months, 3 months, 3 weeks, 5 days, etc. Although a number of time ranges are provided, it should be understood that the time range may be customer definable, application pre-defined, established by the credit provider, established by law or statute, state or country dependent, or the like.

At 854, location information 803 includes real-time location information obtained from the positioning system. Real-time location information would be location information 803 that is generated in real time by the positioning system. The real-time location information would be constantly replaced as location information 803 generated by the positioning system received at the computer system, e.g., location information evaluator 804.

In one embodiment, location information 803 provided by mobile device 110 is coordinate data. Therefore, to determine an address, the coordinate data is cross-referenced with one or more different coordinate-to-address determination sources such as: mapping software, surveyor data that includes business and/or residential information, County assessor's information, or other coordinate-to-address determiners.

Included with location information 803 would be the level of accuracy of the location information. As such, when the location information coordinate data is cross-referenced with the one or more different coordinate-to-address determination sources, the resulting address may be specific or may be a general ballpark area.

The high level of accuracy indication about the coordinate data would likely allow a specific address to be determined when location information 803 is cross-referenced with the one or more different coordinate-to-address determination sources.

The medium level of accuracy indication about the coordinate data may allow a specific address to be determined when location information 803 is cross-referenced with the one or more different coordinate-to-address determination sources, or may result in a general address area. The determination would be based on the actual level of accuracy, the density of businesses and residences within the radius of the location information, and the like. For example, in an area with houses on acre plots, the medium level of accuracy would indicate a specific house. However, in an area with clusters of businesses, such as a strip mall, the medium level of accuracy may only be able to narrow the business address to one of a few different possibilities.

Except for the most rural cases or the largest company buildings, the low level of accuracy indication about the coordinate data would not allow a specific address to be determined when location information 803 is cross-referenced with the one or more different coordinate-to-address determination sources. However, even at the low level of accuracy, the number of possible street names for a home or business address would be reduced.

In one embodiment, the customer's likely home location is determined from location information 803 provided by mobile device 110. The computer system, e.g., location information evaluator 804, would evaluate the historical location information received from the device for a plurality of prior overnight time periods over a plurality of different nights. For example, location information 803 can be organized into time periods, e.g., midnight to 5 am and then reviewed for a prior time period, e.g., weeks, months, etc.

The likely home location is then determined based on the historical location information evaluation. For example, by sorting and then tallying the locations of mobile device 110 during the selected time period (e.g., the past 45 days), it is likely that the location that is found most often is where the customer resides at night. Thus, it is likely the customer's home location.

The customer's likely home location, and the associated accuracy value of location information 803, is then cross-referenced with the one or more different coordinate-to-address determination sources to generate an address. If the accuracy of the likely home location is high enough, a complete address for the customer's likely home is obtained. The complete address is then prefilled into the home address portion of BNPL application.

However, if the accuracy of the likely home location is not high enough to obtain a specific address, at least some level of information about the likely home location is obtained and provided to BNPL application. For example, a prefill capability for the BNPL application can be simplified, or a drop-down menu populated, by knowing what is local to the likely home location. As such, when the customer is filling out the street address, the likely home location information is used to limit the number of possible streets that are offered in a drop-down menu, a quick fill such as a type completion algorithm, or the like.

For example, if the customer starts typing with the letter ‘M’, the limited number of possible streets within the likely home location area will cause BNPL application to offer only those M street names. In this example, Maple, Moore, and Murray. After the customer types ‘M’, the application will present the customer with the prefill options of Maple, Moore, and Murray, from which the customer can select. Alternatively, if the customer continues by typing a ‘u’, the prefill will complete Murray as it is the only street within the likely home location containing those starting letters. Similarly, in the drop-down menu context, every street name within the likely home location would be provided in the drop-down menu and the customer would select the correct street name from the drop-down menu.

Likewise, the customer's likely work address is determined from location information 803 provided by mobile device 110. The computer system, e.g., location information evaluator 804, would evaluate the historical location information received from the device for a plurality of prior daytime periods over a plurality of different days. For example, the location information 803 can be organized into time periods, e.g., 9 am to 4 pm, and then reviewed for a prior time period, e.g., weeks, months, etc.

A likely work address is then determined based on the historical location information evaluation. For example, by sorting and then tallying the locations where mobile device 110 was located during the selected time period (e.g., the past 30 days), it is likely that the location that is found most often is where the customer works. Thus, it is likely the location of the customer's work address.

Similar to above, the customer's likely work location, and the associated accuracy value of location information 803, is then cross-referenced with the one or more different coordinate-to-address determination sources, to generate an address. If the accuracy of the likely work location is high enough, a complete work address for the customer is likely obtained. The complete work address is then prefilled into the work address portion of BNPL application.

As recited above, if the accuracy of the likely work location is not high enough to obtain a specific address, at least some level of information about the likely work location is obtained and provided to BNPL application. For example, a prefill capability for the BNPL application can be simplified, or a drop-down menu populated, by knowing what is local to the likely work location. As such, when the customer is filling out the street address, the likely work location information is used to limit the number of possible streets that are offered in a drop-down menu, the quick fill type completion algorithm, or the like.

It should be appreciated that information for a number of different locations can be obtained in the same manner as described above. For example, the historical location information could be used, by the computer system, to determine an amount of time that the customer has spent at a store location. The amount could be the total amount of time, the amount of time over the past month, week, or the like. If the amount of time surpasses an established threshold, the BNPL product pass 170 would receive a recommendation for an initial credit limit increase for the customer.

Thus, the location information can be used to determine one or more of: a full or partial home address, a full or partial work address, a location where the application was completed, locations where the customer spends a lot of time, locations where the customer does not go, and the like.

FIG. 8C is a flowchart 875 of a method for using position location information to verify information provided by customer 101 on the BNPL application, in accordance with an embodiment. With reference now to 880 of FIG. 8C, one embodiment compares, at the computer system, e.g., location information evaluator 804, the location information from the positioning system with other location information provided on the BNPL application.

In one embodiment, the other location information provided within the BNPL application is information provided by the customer. Additionally, BNPL application could include other location information obtained from a driver's license scan or search, from a search utilizing the mobile number provided by the mobile device, from the user specific information engine 220 of FIG. 3 which uses some customer identification and/or device identification information to perform a search for information. One or more of the sources may provide the resultant information into the BNPL application.

Verification

For example, location information 803 was used by location information evaluator 804 to determine that the customer's home address is 123 Market Street. The other sources have also provided a home address of 123 Market Street to be prefilled into BNPL application. Since the comparing of the location information 803 obtained from mobile device 110 with the information for the BNPL application obtained from another source matches, a verification of the probable home address is made.

In the updating example, location information evaluator 804 determined that the customer's home address is likely 123 Market Street. However, information obtained from one or more of the other sources have provided a different home address, e.g., 99 Onion Way to be prefilled into BNPL application. Since the comparison of the location information 803 obtained from mobile device 110 with the information obtained from another source resulted in a difference between the two possible addresses, the information obtained from the one or more other sources is replaced with the location information 803 during the prefilling of BNPL application.

In one embodiment, in addition to replacing the location information obtained from the one or more other sources with the location information 803 from mobile device 110 in the BNPL application, the location information 803 from mobile device 110 can also be provided to the one or more of the other sources that had provided a different address. Such that the one or more other sources, e.g., 220 et al., will contain the updated location information.

Since there are a number of home addresses found, location information evaluator 804 compares the likely home address determined from the downloaded location information 803 with the home address provided on the BNPL application.

Referring now to 881 of FIG. 8C, one embodiment makes, at the computer system, e.g., fraud determination module 805 of FIG. 8A, a risk assessment based on a result of the comparison. The following discussion utilizes the home address for the comparison. However, it should be appreciated that any or all addresses determined to be of interest in the application, e.g., home, work, etc. can be subject to comparison. However, for purposes of clarity, the following example refers to the home address.

For example, when the comparison results in a similar or a matching home address as described in the verification portion, a risk solution from the risk assessment, would likely result in a low concern for fraud, e.g., it is likely that the address in the BNPL application is correct.

In contrast, when the comparison results in a dissimilarity, as described in the updating/replacing section, a risk assessment would likely result in a concern of medium or high-level fraud. For example, depending upon the source that provided the conflicting location information, the level of fraud risk would likely, but not necessarily, be different. For example, if the information was input by user specific information engine 220, the difference may be due to an incorrect match with the customer, the customer having moved, or the like. In that case, the level of fraud risk may be set to medium which would, in one embodiment, result in the customer receiving a BNPL product at a reduced monetary value.

However, if the incorrect information was input into BNPL application by the customer, the difference is likely due to error or deceit. Thus, a risk assessment would likely result in a higher fraud risk. In one embodiment, due to the higher fraud risk, the customer would receive a denial of the credit account, e.g., no credit account 545.

Alternatively, prior to denying the credit account, the customer may receive an additional question about the inconsistency of the home address provided in BNPL application. If the customer recognizes the mistake, and corrects the field to include a home address that matches the historical location information determination, then it is probable that the fraud risk level would be lowered to either medium or a low concern, e.g., the customer receiving a BNPL product with no reduction in value.

### Example Computer System Environment

With reference now to FIG. 9, portions of the technology for providing a communication composed of computer-readable and computer-executable instructions that reside, for example, in non-transitory computer-readable medium for storing instructions of a computer system. That is, FIG. 9 illustrates one example of a type of computer that can be used to implement embodiments of the present technology. FIG. 9 represents a system or components that may be used in conjunction with aspects of the present technology. In one embodiment, some or all of the components described herein may be combined with some or all of the components of FIG. 9 to practice the present technology.

FIG. 9 illustrates a computer system 900 used in accordance with embodiments of the present technology. It is appreciated that system 900 of FIG. 9 is only an example and that the present technology can operate on or within a number of different computer systems including general purpose networked computer systems, embedded computer systems, routers, switches, server devices, customer devices, various intermediate devices/artifacts, stand-alone computer systems, mobile devices, personal data assistants, televisions and the like. As shown in FIG. 9, computer system 900 of FIG. 9 is well adapted to having peripheral computer readable media 902 such as, for example, an external hard drive, a compact disc, a flash drive, a thumb drive, a wireless radio enabled device, and the like coupled thereto.

Computer system 900 of FIG. 9 includes an address/data/control bus 904 for communicating information, and a processor 906A coupled to bus 904 for processing information and instructions. As depicted in FIG. 9, system 900 is also well suited to a multi-processor environment in which a plurality of processors 906A, 906B, and 906C are present. Conversely, system 900 is also well suited to having a single processor such as, for example, processor 906A. Processors 906A, 906B, and 906C may be any of various types of microprocessors. Computer system 900 also includes data storage features such as a computer usable volatile memory 908, e.g., random access memory (RAM), coupled to bus 904 for storing information and instructions for processors 906A, 906B, and 906C.

System 900 also includes computer usable non-volatile memory 910, e.g., read only memory (ROM), coupled to bus 904 for storing static information and instructions for processors 906A, 906B, and 906C. Also present in system 900 is a data storage unit 912 (e.g., a magnetic disk drive, optical disk drive, solid state drive (SSD), and the like) coupled to bus 904 for storing information and instructions. Computer system 900 also includes an optional alpha-numeric input device 914 including alphanumeric and function keys coupled to bus 904 for communicating information and command selections to processor 906A or processors 906A, 906B, and 906C. Computer system 900 also includes an optional cursor control device 916 coupled to bus 904 for communicating customer input information and command selections to processor 906A or processors 906A, 906B, and 906C. Optional cursor control device may be a touch sensor, gesture recognition device, and the like. Computer system 900 of the present embodiment also includes an optional display device 918 coupled to bus 904 for displaying information.

Referring still to FIG. 9, optional display device 918 of FIG. 9 may be a liquid crystal device, cathode ray tube, OLED, plasma display device or other display device suitable for creating graphic images and alpha-numeric characters recognizable to a customer. Optional cursor control device 916 allows the computer user to dynamically signal the movement of a visible symbol (cursor) on a display screen of display device 918. Many implementations of cursor control device 916 are known in the art including a trackball, mouse, touch pad, joystick, non-contact input, gesture recognition, voice commands, bio recognition, and the like. In addition, special keys on alpha-numeric input device 914 capable of signaling movement of a given direction or manner of displacement. Alternatively, it will be appreciated that a cursor can be directed and/or activated via input from alpha-numeric input device 914 using special keys and key sequence commands.

Computer system 900 also includes an I/O device 920 for coupling system 900 with external entities. For example, in one embodiment, I/O device 920 is a modem for enabling wired or wireless communications between system 900 and an external network such as, but not limited to, the Internet or intranet. A more detailed discussion of the present technology is found below.

Referring still to FIG. 9, various other components are depicted for system 900. Specifically, when present, an operating system 922, applications 924, modules 926, and data 928 are shown as typically residing in one or some combination of computer usable volatile memory 908, e.g. random-access memory (RAM), and data storage unit 912. However, it is appreciated that in some embodiments, operating system 922 may be stored in other locations such as on a network or on a flash drive; and that further, operating system 922 may be accessed from a remote location via, for example, a coupling to the internet. In one embodiment, the present technology, for example, is stored as an application 924 or module 926 in memory locations within RAM 908 and memory areas within data storage unit 912. The present technology may be applied to one or more elements of described computer system 900.

System 900 also includes one or more signal generating and receiving device(s) 930 coupled with bus 904 for enabling system 900 to interface with other electronic devices and computer systems. Signal generating and receiving device(s) 930 of the present embodiment may include wired serial adaptors, modems, and network adaptors, wireless modems, and wireless network adaptors, and other such communication technology. The signal generating and receiving device(s) 930 may work in conjunction with one or more communication interface 932 for coupling information to and/or from system 900. Communication interface 932 may include a serial port, parallel port, Universal Serial Bus (USB), Ethernet port, Bluetooth, thunderbolt, near field communications port, WiFi, Cellular modem, or other input/output interface. Communication interface 932 may physically, electrically, optically, or wirelessly (e.g., via radio frequency) couple computer system 900 with another device, such as a mobile telephone, radio, or computer system.

The computing system 900 is only one example of a suitable computing environment and is not intended to suggest any limitation as to the scope of use or functionality of the present technology. Neither should the computing environment be interpreted as having any dependency or requirement relating to any one or combination of components illustrated in the computer system 900.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method comprising:
receiving, at a buy now pay later (BNPL) product provider computing system, a BNPL application from a customer, said BNPL application including identification information for said customer;
utilizing, at said BNPL product provider computing system, said identification information for said customer to identify an existing credit account associated with said customer;
generating, at said BNPL product provider computing system and based on said existing credit account, a BNPL product with associated terms;
providing, to a mobile device of said customer and from said BNPL product provider computing system, said BNPL product with associated terms;
accepting, via a customer input to said mobile device, said BNPL product with associated terms;
providing, from said mobile device and to said BNPL product provider computing system, said acceptance of said BNPL product with associated terms;
receiving, at said mobile device and from said BNPL product provider computing system, said BNPL product;
providing, from said mobile device and to a retail computing system, said BNPL product during a checkout process; and
completing, at said retail computing system, a transaction with said BNPL product.

2. The method of claim 1 further comprising:
requesting, via said retail computing system, a transaction authorization from said BNPL product provider computing system during said checkout process;
receiving, at said retail computing system, said transaction authorization from said BNPL product provider computing system; and
completing said transaction with said BNPL product upon receipt of said transaction authorization at said retail computing system.

3. The method of claim 1 further comprising:
providing, from said retail computing system, a transaction completion confirmation to said BNPL product provider.

4. The method of claim 3 further comprising:
storing, in a BNPL product provider database, said BNPL product and associated terms in conjunction with said identification information for said customer upon receipt of said transaction completion confirmation from said retail computing system.

5. The method of claim 1, wherein said associated terms comprise:
a fee information;
a reward information;
a time period for repayment of said BNPL product; and
a predefined payment amount and a recurring payment due date within said time period for said repayment.

6. The method of claim 1, further comprising:
receiving a purchase amount as part of said BNPL application from said customer.

7. The method of claim 1, further comprising:
determining that said customer has previously utilized a different BNPL product.

8. The method of claim 1, further comprising:
utilizing said identification information about said customer to perform a credit prescreen.

9. The method of claim 8, further comprising:
generating, based on a result of said credit prescreen, said BNPL product with associated terms.

10. A non-transitory computer-readable medium for storing instructions, said instructions comprising:
one or more instructions which, when executed by one or more processors, cause one or more processors to:
receive a buy now pay later (BNPL) application for a customer, said BNPL application including identification information about said customer;
utilize said identification information about said customer to identify an existing credit account associated with said customer;
generate, based on said existing credit account, a plurality of BNPL products with associated terms;
provide said plurality of BNPL products with associated terms to a customer accessible computing system;
receive a selection of a BNPL product of said plurality of BNPL products, from said customer accessible computing system;
automatically generate an agreement with said associated terms for said selected BNPL product;
automatically provide, to a retail computing system, said selected BNPL product during a checkout process; and
complete a transaction with said BNPL product.

11. The non-transitory computer-readable medium of claim 10, wherein said customer accessible computing system is a mobile device of said customer.

12. The non-transitory computer-readable medium of claim 10, wherein said BNPL application is received from a mobile device of said customer.

13. The non-transitory computer-readable medium of claim 10, wherein said one or more instructions further cause one or more processors to:
receive a request from said retail computing system for a transaction authorization during said checkout process; and
provide said transaction authorization to said retail computing system.

14. The non-transitory computer-readable medium of claim 13, wherein said one or more instructions further cause one or more processors to:
store, in a database, said selected BNPL product in conjunction with said identification information about said customer and said associated terms, upon receipt of a transaction completion confirmation from said retail computing system.

15. The non-transitory computer-readable medium of claim 10, wherein said associated terms comprise:
a fee information;
a reward information;
a time period for repayment of said selected BNPL product; and
a predefined payment amount and a recurring payment due date within said time period for said repayment.

16. The non-transitory computer-readable medium of claim 10, wherein said one or more instructions further cause one or more processors to:
provide an incentive with at least one of said plurality of BNPL products.

17. A system comprising:
a buy now pay later (BNPL) product provider computing system to:
receive an inquiry about a BNPL product for a customer, said inquiry including identification information for said customer;
utilize said identification information about said customer to identify an existing credit account associated with said customer;
utilize said identification information for said customer to perform a credit prescreen;
generate, based on said existing credit account and a result of said credit prescreen, a plurality of BNPL products, each of said plurality of BNPL products with associated terms;
provide said plurality of BNPL products with associated terms to a customer accessible computing system;
receive a selection of one of said plurality of BNPL products with associated terms from said customer;
automatically generate an agreement with said associated terms of said one of said plurality of BNPL products when said one of said plurality of BNPL products is selected by said customer;
automatically provide, to a retail computing system, said selected one of said plurality of BNPL products during a checkout process; and
complete a transaction with said selected one of said plurality of BNPL products.

18. The system of claim 17 wherein said inquiry about said BNPL product is received from a mobile device of said customer.

19. The system of claim 17 further comprising:
receive a request from said retail computing system for a transaction authorization during said checkout process;
provide said transaction authorization to said retail computing system; and
store, in a database, said selected one of said plurality of BNPL products in conjunction with said identification information for said customer and said associated terms, upon receipt of a transaction completion confirmation from said retail computing system.

20. The system of claim 17 wherein said associated terms comprise:
a fee information;
a reward information;
a time period for repayment of said selected one of said plurality of BNPL products; and
a predefined payment amount and a recurring payment due date within said time period for said repayment.
